(19) United States
(12) Patent Application Publication
(10) Pub. No.: US 2026/0323542 A1
(43) Pub. Date: Oct. 15, 2026

(54) METHOD AND DEVICE FOR CONTROLLING SYNCHRONIZATION SIGNAL TRANSMIT POWER AND COMPUTER READABLE STORAGE MEDIUM

(71) Applicant: GUANGDONG OPPO MOBILE TELECOMMUNICATIONS CORP., LTD., Dongguan (CN)

(72) Inventors: Teng MA, Dongguan (CN); Shichang ZHANG, Dongguan (CN); Zhenshan ZHAO, Dongguan (CN)

(21) Appl. No.: 19/462,152

(22) Filed: Jan. 28, 2026

Related U.S. Application Data
(63) Continuation of application No. PCT/CN2023/134503, filed on Nov. 27, 2023.

(51) Int. Cl. H04W 52/50; H04W 52/32; H04W 52/36

(52) U.S. Cl. CPC H04W 52/50; H04W 52/325; H04W 52/367

(57) ABSTRACT

A method and device for controlling synchronization signal transmit power and a non-transitory computer readable storage medium are provided. The method is applied to a terminal, and includes operations as follows. Channel access is performed on at least one first resource block RB set. A first sidelink synchronization signal block S-SSB transmit power on the at least one first RB set is determined based on a channel access result of the at least one first RB set.

### CROSS-REFERENCE TO RELATED APPLICATION

This is a continuation application of International Patent Application No. PCT/CN2023/134503, filed on Nov. 27, 2023, the disclosure of which is hereby incorporated by reference in its entirety.

### BACKGROUND

In the current Sidelink (SL) technology, a Sidelink Synchronization Signal Block (S-SSB) transmit power is allocated to a Resource Block (RB) set when the Resource Block (RB) set that is to transmit the S-SSB is determined, and then channel access is performed. The RB set that can transmit the S-SSB is determined based on the result of channel access. The RB set that can transmit the S-SSB may be different from the RB set that is determined in advance to transmit the S-SSB, because a part of RB sets cannot transmit the S-SSB due to failure of the channel access. Therefore, the S-SSB transmit power allocated to the part of RB set is wasted.

### SUMMARY

The embodiments of the present disclosure relate to the technical field of communication, and particularly to a method and device for controlling a synchronization signal transmit power and a non-transitory computer readable storage medium.

A first aspect of the embodiments of the present disclosure provides a method for controlling a synchronization signal transmit power, which is applied to a terminal, and includes operations as follows. Channel access is executed on at least one first resource block RB set. A first sidelink synchronization signal block S-SSB transmit power on the at least one first RB set is determined based on a channel access result of the at least one first RB set.

A second aspect of the embodiments of the present disclosure provides a terminal including a processor and a memory. The memory is used for storing a computer program, and the processor is configured for calling and running the computer program stored in the memory to execute the method for controlling a synchronization signal transmit power described above.

A third aspect of the embodiments of the present disclosure provides a non-transitory computer-readable storage medium for storing a computer program that causes a computer to execute the method for controlling a synchronization signal transmit power described above.

### BRIEF DESCRIPTION OF THE DRAWINGS

The accompanying drawings described herein are intended to provide a further understanding of the present disclosure, and constitute a part of the present disclosure, and the schematic embodiments of the present disclosure and the description thereof are intended to explain the present disclosure, and do not constitute an undue limitation of the present disclosure. In the drawings:

FIG. 1 is a schematic diagram of sidelink communication within network coverage according to an embodiment of the present disclosure;

FIG. 2 is a schematic diagram of sidelink communication with partial network coverage according to an embodiment of the present disclosure;

FIG. 3 is a schematic diagram of sidelink communication outside the network coverage according to the embodiment of the present disclosure;

FIG. 4 is a schematic diagram of sidelink communication with a central control node according to an embodiment of the present disclosure;

FIG. 5 is a schematic diagram of a unicast transmission method according to an embodiment of the present disclosure;

FIG. 6 is a schematic diagram of a multicast transmission method according to an embodiment of the present disclosure;

FIG. 7 is a schematic diagram of a broadcast transmission method according to an embodiment of the present disclosure;

FIG. 8 is a schematic diagram of a time slot structure in an NR-V2X according to an embodiment of the present disclosure;

FIG. 9 is a schematic diagram showing a change of OFDM symbols available in the time slot in different PSSCH transmissions according to an embodiment of the present disclosure;

FIG. 10 is a schematic diagram of a mapping method of a second-order SCI according to an embodiment of the present disclosure;

FIG. 11 is a schematic diagram of a time-frequency domain position of a PSCCH DMRS according to an embodiment of the present disclosure;

FIG. 12 is a schematic diagram of time domain positions of four DMRS symbols when the PSSCH has 13 symbols according to the embodiment of the present disclosure;

FIG. 13 is a schematic diagram of a single-symbol DMRS frequency domain type 1 according to an embodiment of the present disclosure;

FIG. 14 is a schematic diagram of time-frequency positions of an SL CSI-RS according to an embodiment of the present disclosure;

FIG. 15 is a schematic diagram of an example of a channel occupancy time and a channel occupancy according to an embodiment of the present disclosure;

FIG. 16 is a schematic diagram of frequency domain resource division according to an embodiment of the present disclosure;

FIG. 17 is a schematic diagram illustrating an example of an S-SSB time domain resource configuration according to an embodiment of the present disclosure;

FIG. 18 is a time-frequency structure diagram of an S-SSB according to an embodiment of the present disclosure;

FIG. 19 is a schematic diagram of S-SSB time-frequency domain mapping according to an embodiment of the present disclosure;

FIG. 20 is a first control/allocation timing diagram of a sidelink synchronization signal transmit power according to an embodiment of the present disclosure;

FIG. 21 is a schematic flowchart of a method for controlling a synchronization signal transmit power according to an embodiment of the present disclosure;

FIG. 22 is a first schematic diagram of an implementation solution for controlling a synchronization signal transmit power according to an embodiment of the present disclosure;

FIG. 23 is a second schematic diagram of an implementation solution for controlling a synchronization signal transmit power according to an embodiment of the present disclosure;

FIG. 24 is a third schematic diagram of an implementation solution for controlling a synchronization signal transmit power according to an embodiment of the present disclosure;

FIG. 25 is a second control/allocation timing diagram of a sidelink synchronization signal transmit power according to an embodiment of the present disclosure;

FIG. 26 is a fourth schematic diagram of an implementation scheme for controlling a synchronization signal transmit power according to an embodiment of the present disclosure;

FIG. 27 is a fifth schematic diagram of an implementation scheme for controlling a synchronization signal transmit power according to an embodiment of the present disclosure;

FIG. 28 is a sixth schematic diagram of an implementation scheme for controlling a synchronization signal transmit power according to an embodiment of the present disclosure;

FIG. 29 is a schematic structural diagram of a composition of a device for controlling a synchronization signal transmit power according to the embodiment of the present disclosure;

FIG. 30 is a schematic structural diagram of a communication device according to an embodiment of the present disclosure; and

FIG. 31 is a schematic structural diagram of a chip according to an embodiment of the present disclosure;

### DETAILED DESCRIPTION

Hereinafter, the technical solutions in the embodiments of the present disclosure are described with reference to the accompanying drawings in the embodiments of the present disclosure, and it is apparent that the described embodiments are a part rather than all of the embodiments of the present disclosure. Based on the embodiments in the present disclosure, all other embodiments obtained by those skilled in the art without creative work fall within the scope of protection of the present disclosure.

The technical solutions of the embodiments of the present disclosure may be applied to various sidelink communication systems. In order to facilitate understanding of the technical solutions of the embodiments of the present disclosure, the related technologies of the embodiments of the present disclosure will be described below, and the related technologies below can be as optional solutions arbitrarily combined with the technical solutions of the embodiments of the present disclosure, and all of them belong to the scope of protection of the embodiments of the present disclosure.

### 1. Sidelink Communication in Different Network Coverage Environments

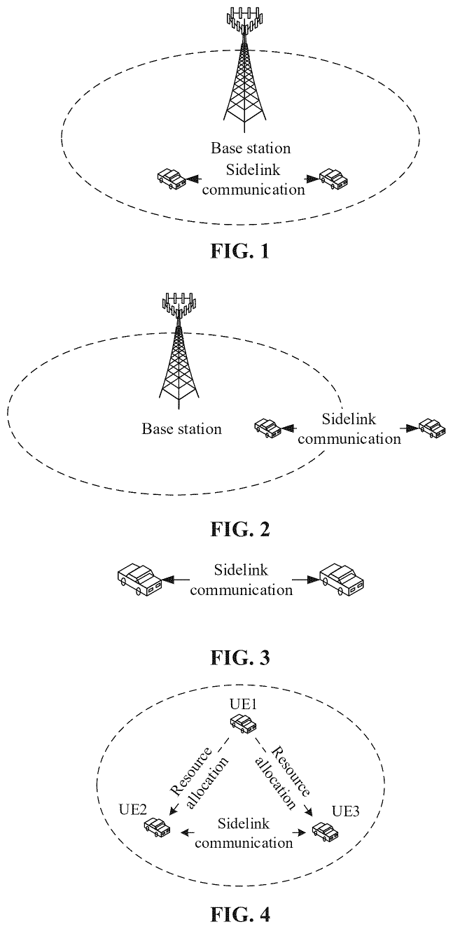

The sidelink communication may be classified, according to the network coverage of the terminal which performs communication, into sidelink communication within the network coverage, sidelink communication with partial network coverage, sidelink communication outside the network coverage, and sidelink communication with a central control node, as shown in FIG. 1, FIG. 2, FIG. 3, and FIG. 4 respectively.

As shown in FIG. 1, in the sidelink communication within network coverage, all terminals which perform sidelink communication are within the coverage range of the same base station, and thus the terminals can perform sidelink communication based on the same sidelink configuration by receiving the configuration signaling of the base station.

As shown in FIG. 2, in the sidelink communication with partial network coverage, a part of terminals which perform sidelink communication are located within the coverage range of the base station, and these part of terminals can receive configuration signaling of the base station, and perform sidelink communication according to the configuration of the base station. However, the terminal outside the network coverage cannot receive the configuration signaling of the base station. In this case, the terminal outside the network coverage determines the sidelink configuration according to pre-configuration information and information carried in a sidelink broadcast channel (PSBCH) sent by the terminal within the network coverage, and thus perform sidelink communication.

As shown in FIG. 3, in sidelink communication outside the network coverage, all terminals that perform sidelink communication are located outside the network coverage, and all terminals determine sidelink configuration according to pre-configuration information and perform sidelink communication.

As shown in FIG. 4, in sidelink communication with a central control node, multiple terminals constitute a communication group, and the communication group has a central control node, such as UE1 in FIG. 4. The central control node may also be called a Cluster Header (CH). The central control node has, but is not limited to, at least one of the following functions: establishing a communication group; the joining and leaving of a group member; performing resource coordination, allocating sidelink transmission resources for other terminals, and receiving sidelink feedback information of other terminals; performing resource coordination with other communication groups.

### 2. Device to Device (D2D)/Vehicle to Everything (V2X)

The Device-to-device communication is a sidelink transmission technology based on D2D, and is different from the traditional cellular system in which communication data is received or sent through the base station, and thus has higher spectral efficiency and lower transmission delay. The V2X system adopts a terminal-to-terminal direct communication manner. The 3rd Generation Partnership Project (3GPP) defines two transmission modes: a first mode and a second mode.

In the first mode, transmission resources of the terminal are allocated by the base station, and the terminal transmits data on the sidelink according to the resources allocated by the base station. The base station may allocate resources for a single transmission to the terminal, or may allocate resources for a semi-static transmission to the terminal. As shown in FIG. 1, the terminal is located within the network coverage, and the network allocates transmission resources for sidelink transmission for the terminal.

In the second mode, the terminal selects a resource in the resource pool for data transmission. As shown in FIG. 3, the terminal is located outside the cell coverage, and the terminal independently selects transmission resources for sidelink transmission in the preconfigured resource pool. Alternatively, in FIG. 1, the terminal independently selects a transmission resource for sidelink transmission in a resource pool configured by the network.

### 3. New Radio-Vehicle to Everything (NR-V2X)

The NR-V2X should support autonomous driving, and thus raise a high requirement for data interaction between vehicles, such as a high throughput, a low latency, a high reliability, a large coverage, a flexible resource allocation, etc.

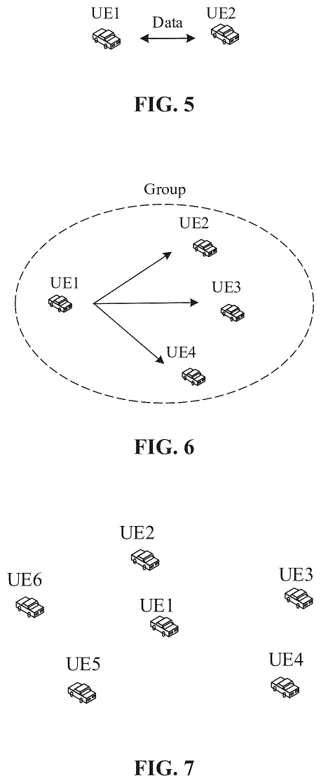

The broadcast transmission mode is supported in the LTE-V2X, and the unicast and multicast transmission modes are introduced in the NR-V2X. The receiving end has only one terminal in the unicast transmission. As shown in FIG. 5, unicast transmission is performed between UE1 and UE2, the receiving end is all terminals in a communication group or all terminals within a certain transmission distance in the multicast transmission. As shown in FIG. 6, UE1, UE2, UE3 and UE4 constitute a communication group, where UE1 transmits data, and other terminal devices in the group are receiving terminals. For the broadcast transmission mode, the receiving end is any terminal around the transmitting terminal. As shown in FIG. 7, UE1 is the transmitting terminal, and other terminals UE2 to UE6 around the transmitting terminal are all receiving terminals.

### 4. NR-V2X System Frame Structure

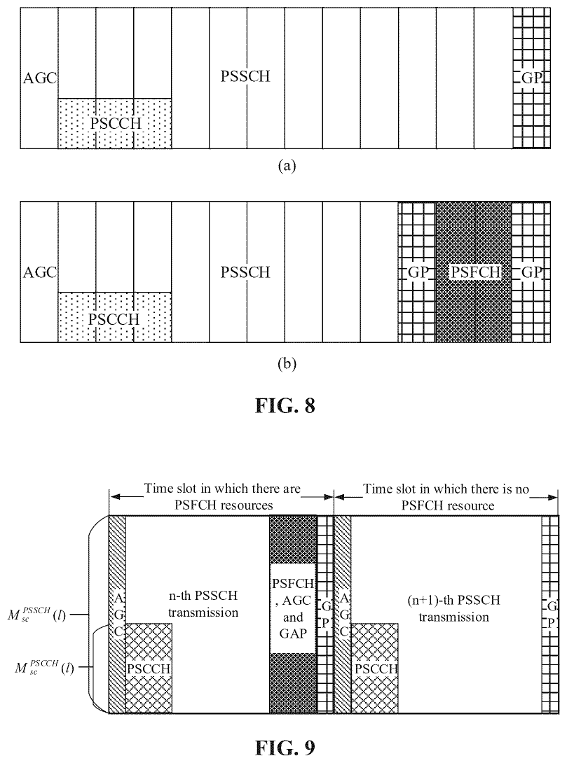

The slot structure in the NR-V2X is shown in FIG. 8.

The diagram (a) in FIG. 8 is a schematic structural diagram of a time slot in which there is no a Physical Sidelink Feedback Channel (PSFCH), and the diagram (b) in FIG. 8 is a schematic structural diagram of a time slot which includes a PSFCH.

The Physical Sidelink Control Channel (PSCCH) in the NR-V2X occupies 2 or 3 Orthogonal Frequency Division Multiplexing (OFDM) symbols starting from the second sidelink symbol of the time slot in the time domain, and may occupy {10, 12, 15, 20, 25} Physical Resource Blocks (PRB) in the frequency domain. In order to reduce the complexity of blind detection on the PSCCH by User Equipment (UE), only one number of PSCCH symbols and one number of PRBs are allowed to be configured in a resource pool. In addition, since the sub-channel is the minimum granularity of resource allocation of the Physical Sidelink Shared Channel (PSSCH) in the NR-V2X, the number of PRBs occupied by the PSCCH must be less than or equal to the number of PRBs included in one sub-channel in the resource pool, to avoid additional restrictions on selection or allocation of PSSCH resources. The PSSCH starts from the second sidelink symbol of the time slot in the time domain, the last time domain symbol in the time slot is a Guard Period (GP) symbol, and the remaining symbols are mapped to the PSSCH. The first sidelink symbol in this slot is a repetition of the second sidelink symbol, and the receiving terminal uses the first sidelink symbol as an Automatic Gain Control (AGC) symbol, and the data on the symbol is usually not used for data demodulation. The PSSCH occupies K sub-channels in the frequency domain, and each sub-channel includes N consecutive PRBs.

When the time slot includes the PSFCH, the second-to-last and third-to-last symbols in the time slot are used as PSFCH transmission, and one time domain symbol before the PSFCH is used as a GP symbol, as shown in diagram (b) of FIG. 8.

### 5. Sidelink PSSCH

In the NR-V2X, the PSSCH carries second-order Sidelink Control Information (SCI) (SCI2-A or SCI2-B) and data information. The second-order SCI adopts a Polar coding manner and fixedly adopts Quadrature Phase Shift Keying (QPSK) modulation. The data part of the PSSCH adopts Low Density Parity Check (LDPC) code, and supports the highest modulation order of 256QAM.

In the NR-V2X, the PSSCH supports at most dual-stream transmission, and uses a unit precoding matrix to map data of two layers to two antenna ports, and only at most one Transport Block (TB) may be transmitted in one PSSCH. However, unlike the transmission mode of the data part of the PSSCH, the modulation symbols transmitted by the second-order SCI on the two streams are identical when the PSSCH adopts the dual-stream transmission mode, which can ensure the reception performance of the second-order SCI in the high-correlation channel.

Since the maximum number of retransmissions of one PSSCH in the NR-V2X is 32, if the PSFCH resource exists in the resource pool and the configuration period of the PSFCH resource is 2 or 4, the available OFDM symbols in the time slots for different PSSCH transmission may change, as shown in FIG. 9. If

$${N}_{symbol}^{PSSCH}$$

is calculated according to the actual number of OFDM symbols in one time slot,

$${Q}_{SCI 2}^{′}$$

may be different since the number of symbols available for PSSCH transmission in a time slot are different, and the change

$${Q}_{SCI 2}^{′}$$

may lead to a change in the size of the TB carried by the PSSCH. In order to ensure that the Transmission Block Size (TBS) remains unchanged during multiple PSSCH transmissions, the real number of PSFCH symbols is not used when calculating

$${N}_{symbol}^{PSSCH} .$$

In addition, the number of Resource Elements (REs) occupied by the PSSCH Demodulation Reference Signal (DMRS) and the number of REs occupied by the Phase-Tracking Reference Signals (PT-RS) which may change during retransmission are also not taken into account when calculating

$${M}_{s c}^{SCI 2} ( l ) .$$

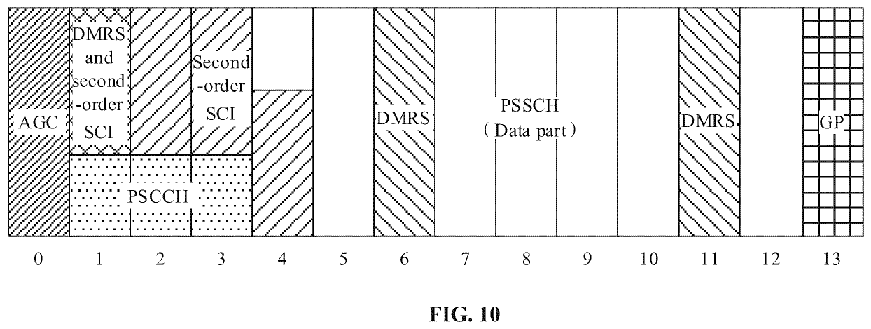

The code rate of the second-order SCI may be dynamically adjusted within a certain range, and the code rate is indicated by the first-order SCI. Therefore, even after the code rate is changed, the receiving end does not need to perform blind detection on the second-order SCI. The modulation symbol of the second-order SCI is mapped from the symbol in which the first PSSCH DMRS is located first in the frequency domain and then in the time domain, and the second-order SCI is mapped to the RE which is not occupied by the DMRS on the OFDM symbols in which the DMRS is located, as shown in FIG. 10.

The data part of the PSSCH in a resource pool may adapt multiple different Modulation and Coding Scheme (MCS) tables, including the conventional 64QAM MCS table, the 256QAM MCS table, and the low spectral efficiency 64QAM MCS table. The MCS table used in one transmission is indicated by the “MCS Table Indication” field in the first order SCI. In order to control the Peak to Average Power Ratio (PAPR), the PSSCH must use continuous PRB transmission. Since the subchannel is the minimum frequency domain resource granularity of the PSSCH, the PSSCH must occupy continuous subchannels.

### 6. Sidelink Transport Block Size

The PSSCH adopts the transport block size (TBS) determination mechanism of the Physical Downlink Shared Channel (PDSCH) and the Physical Uplink Shared Channel (PUSCH) in New Radio (NR). That is, the TBS is determined according to a reference value of the number of REs for the PSSCH in the time slot where the PSSCH is located, so that the actual code rate is as close as possible to the target code rate. The purpose of using the reference value of the number of REs instead of the actual number of REs here is to ensure that the number of REs for determining the TBS in the PSSCH retransmission process remains unchanged, so that the determined TBS is the same. In order to achieve this purpose, the reference value N_{RE} of the number of REs occupied by the PSSCH in the TBS determination process is determined according to formula (1):

$${N}_{R E} = {N}_{R E}^{′} \cdot {n}_{P R B} - {N}_{R E}^{SCI , 1} - {N}_{R E}^{SCI , 2} \qquad ( 1 )$$

n_{PRB} represents the number of PRBs occupied by the PSSCH,

$${N}_{R E}^{SCI , 1}$$

represents the number of REs occupied by the first-order SCI (including the REs occupied by the PSCCH DMRS),

$${N}_{R E}^{SCI , 2}$$

denotes the number of REs occupied by the second-order SCI, and

$${N}_{R E}^{′}$$

denotes the number of reference REs available for the PSSCH in one PRB and is determined by formula (2):

$${N}_{R E}^{′} = {N}_{sc}^{R B} ( {N}_{symb}^{s h} - {N}_{symb}^{P S F C H} ) - {N}_{o h}^{P R B} - {N}_{R E}^{DMRS} \qquad ( 2 )$$

$${N}_{s c}^{R B} = 12$$

represents the number of subcarriers in a PRB,

$${N}_{symb}^{s h}$$

represents the number of symbols available for sidelink in a slot, excluding the last GP symbol and the first symbol for AGC.

$${N}_{symb}^{P S F C H} = 0$$

or 3, and the value is indicated by the “PSFCH symbol number” field in the first-order SCI, and is a reference value of the number of symbols occupied by the PSFCH. The value of

$${N}_{o h}^{P R B}$$

is configured by a Radio Resource Control (RRC) layer parameter, and is used to represent a reference value of the number of REs occupied by PT-RS and CSI-RS.

$${N}_{R E}^{D M R S}$$

represents the average number of DMRS REs in a time slot, and is related to the allowed DMRS pattern in the resource pool, as shown in Table 1.

TABLE 1
Correspondence between allowed DMRS patterns and
${N}_{RE}^{DMRS} in resource pool$

| DMRS pattern | ${N}_{RE}^{DMRS}$ |
|---|---|
| {2} | 12 |
| {3} | 18 |
| {4} | 24 |
| {2, 3} | 15 |
| {2, 4} | 18 |
| {3, 4} | 21 |
| {2, 3, 4} | 18 |

### 7. Sidelink DMRS

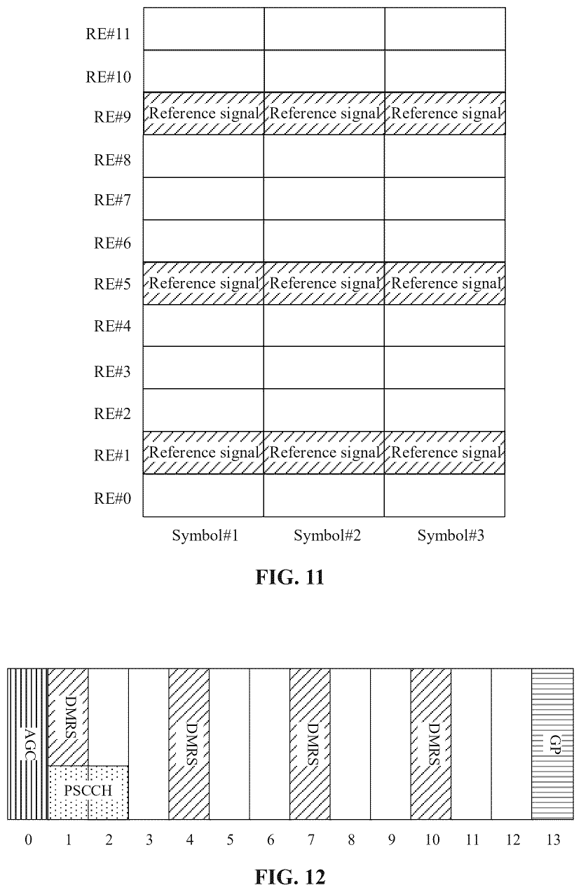

In the NR-V2X, the DMRS pattern of the PSCCH is the same as that of the NR Physical Downlink Control Channel (PDCCH). That is, the DMRS exists on each OFDM symbol of the PSCCH, and is located on {#1, #5, #9} REs of one PRB in the frequency domain, as shown in FIG. 11. The DMRS sequence of the PSCCH is generated by Equation (3):

$${r}_{l} ( m ) = \frac{1}{\sqrt{2}} ( 1 - 2 c ( m ) ) + j \frac{1}{\sqrt{2}} ( 1 - 2 c ( m + 1 ) ) \qquad ( 3 )$$

The pseudo-random sequence c(m) is initialized according to

$${c}_{init} = ( {2}^{17} ( {N}_{symb}^{slot} {n}_{s , f}^{μ} + l + 1 ) ( 2 {N}_{I D} + 1 ) + 2 \text{?} ) mod {2}^{31} ,$$

where l denote the index of the OFDM symbol where the DMRS is located in the time slot,

$${n}_{s , f}^{μ}$$

denotes the index of the time slot where the DMRS is located in the system frame, and

$${N}_{symb}^{slot}$$

represents the number of OFDM symbols in one time slot. N_{ID}∈{0, 1, . . . , 65535}, and a specific value of N_{ID} in a resource pool is configured or preconfigured by the network.

The design in the NR Uu interface is used for reference in the NR-V2X, and multiple time-domain PSSCH DMRS patterns are used in the NR-V2X. The number of available DMRS patterns in a resource pool is related to the number of PSSCH symbols in the resource pool. For a specific number of PSSCH symbols (including the first AGC symbol) and the number of PSCCH symbols, the available DMRS patterns and the position of each DMRS symbol in the pattern are shown in Table 2. FIG. 12 shows a schematic diagram of the time domain positions of four DMRS symbols when the PSSCH has 13 symbols.

TABLE 2
Number and position of DMRS symbols under different
numbers of PSSCH symbols and PSCCH symbols

| Number of | DMRS symbol position | | | | | |
|---|---|---|---|---|---|---|
| PSSCH | (relative to the first AGC symbol position) | | | | | |
| symbols | The number of | | | The number of | | |
| (including | PSCCH symbols is 2 | | | PSCCH symbols is 3 | | |
| first AGC | Number of DMRS Symbols | | | Number of DMRS Symbols | | |
| symbol) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

If multiple time domain DMRS patterns are configured in the resource pool, the time domain DMRS pattern is selected by the transmitting UE and indicated in the first-order SCI. Such design allows a high-speed moving UE to select a high-density DMRS pattern, thereby ensuring the accuracy of channel estimation, a low-speed moving UE may adapt a low-density DMRS pattern, thereby improving spectral efficiency.

The generation method of the PSSCH DMRS sequence is almost identical to the generation method of the PSCCH DMRS sequence, the only difference is that in the initialization formula cᵢₙᵢₜ of the pseudo-random sequence c(m),

$${N}_{ID} = {\sum }_{i = 0}^{L - 1} {p}_{i} \cdot {2}^{L - 1 - i} ,$$

pᵢ denotes the i-th Cyclic Redundancy Check (CRC) of the PSCCH for scheduling the PSSCH, L=24, which is the number of bits of the PSCCH CRC.

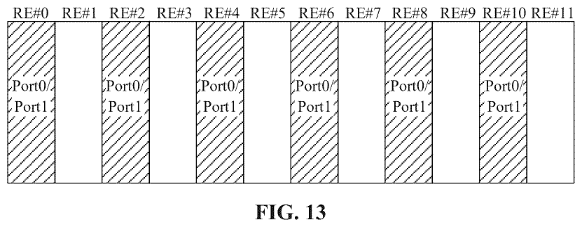

Two frequency domain DMRS patterns, namely, DMRS frequency domain type 1 and DMRS frequency domain type 2, are supported in the NR PDSCH and PUSCH. For each frequency domain type, there are two different types which are a single DMRS symbol and dual DMRS symbol. Single-symbol DMRS frequency domain type 1 supports 4 DMRS ports, and single-symbol DMRS frequency domain type 2 may support 6 DMRS ports. The number of ports supported by the dual DMRS symbol doubles. However, in the NR-V2X, since the PSSCH only needs to support two DMRS ports at most, only the single-symbol DMRS frequency domain type 1 is supported, as shown in FIG. 13.

### 8. Sidelink Channel State Information Reference Signal (CSI-RS)

In order to better support unicast communication, sidelink CSI-RS (SL CSI-RS) is supported in the NR-V2X, and the SL CSI-RS is sent only when the following three conditions are met:
1) the UE transmits the PSSCH, that is, the UE cannot transmit only the SL CSI-RS;
2) a high-layer signaling activates reporting of the sidelink CSI;
3) when the high-layer signaling activates reporting of the sidelink CSI, a corresponding bit in the second-order SCI transmitted by the UE triggers reporting of the sidelink CSI.

The maximum number of ports supported by the SL CSI-RS is 2. When the number of ports is two, the SL CSI-RSs of different ports are code-division multiplexed on two adjacent REs of the same OFDM symbol. The number of SL CSI-RS of each port in one PRB is 1, that is, the density is 1. Therefore, the SL CSI-RS at most appears on one OFDM symbol in one PRB, and the location of the OFDM symbol is determined by the transmitting terminal. In order to avoid affecting the resource mapping between the PSCCH and the second-order SCI, the SL CSI-RS cannot be located in the same OFDM symbol as the PSCCH and the second-order SCI. Since the channel estimation accuracy of the OFDM symbol where the PSSCH DMRS is located is high, and the SL CSI-RS of the two ports will occupy two consecutive REs in the frequency domain, the SL-CSI-RS cannot be transmitted on the same OFDM symbol as the PSSCH DMRS. The position of the OFDM symbol in which the SL CSI-RS is located is indicated by the parameter sl-CSI-RS-FirstSymbol in the PC5 RRC.

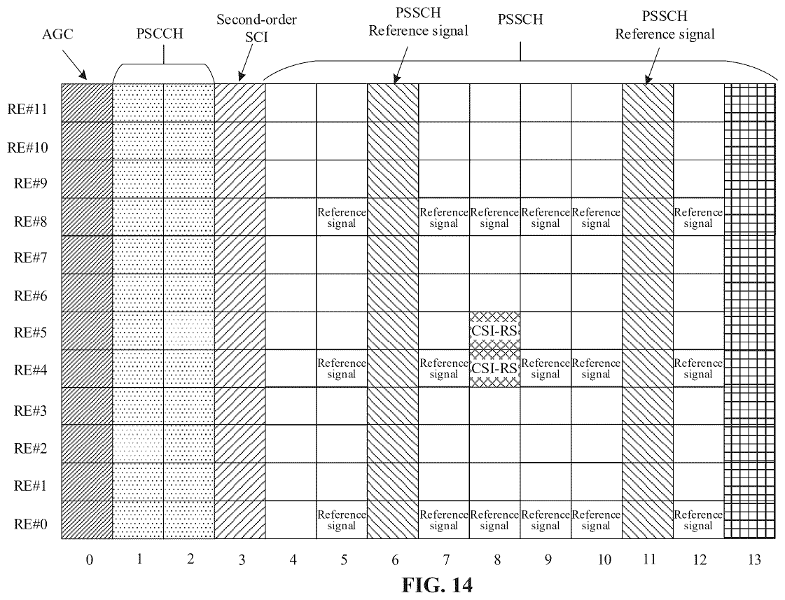

The position of the first RE occupied by the SL CSI-RS in one PRB is indicated by the parameter sl-CSI-RS-FreqAllocation in the PC5 RRC. The parameter is a bitmap with the length of 12 corresponding to 12 REs in one PRB if the SL CSI-RS supports one port. The parameter is a bitmap with the length of 6 if the SL CSI-RS supports two ports, in which the SL CSI-RS occupies and two REs 2f(1) and 2f(1)+1, f(1) represents the index of a bit having value 1 in the above bitmap. The frequency domain position of the SL CSI-RS is also determined by the transmitting terminal, but the determined frequency domain position of the SL CSI-RS cannot collide with the PT-RS. FIG. 14 is a schematic diagram of the time-frequency positions of the SL CSI-RS. In FIG. 14, the number of ports of SL CSI-RS is 2, sl-CSI-RS-FirstSymbol is 8, and sl-CSI-RS-FreqAllocation is [b₅,b₄,b₃,b₂,b₁,b₀]=[0, 0, 0, 1, 0, 0].

### 9. 5G Unlicensed (Licensed-Free) Spectrum Communication (NR-U)

The NR system introduced by the 3GPP R15 standard is a communication technology used for existing and new licensed spectrum. The NR system can achieve seamless coverage of the cellular network, the high spectral efficiency, the high peak rate, and the high reliability. In the Long Term Evolution (LTE) system, the unlicensed spectrum (or licensed-free spectrum) is used, as a complementary band for the licensed spectrum, for the cellular networks. Similarly, the NR system can also use the unlicensed spectrum as a part of 5G cellular network technology to provide services to the users. In the 3GPP R16 standard, the NR system applied on the unlicensed spectrum, called as NR-unlicensed (NR-U), is discussed.

The NR-U system supports two networking modes: licensed spectrum assisted access and unlicensed spectrum independent access. The licensed spectrum assisted access needs to access the network through the licensed spectrum, and the unlicensed spectrum is used as a secondary carrier. In the unlicensed spectrum independent access, the unlicensed spectrum may be independently used for networking, and the UE can directly access the network through the unlicensed spectrum. The range of the unlicensed spectrum used by the NR-U system introduced in the 3GPP R16 is centered on the 5 GHz and 6 GHz bands, such as 5925-7125 MHz in the United States, or 5925-6425 MHz in Europe. In the R16 standard, the band 46 (5150 MHz-5925 MHz) is newly defined as the unlicensed spectrum.

The unlicensed spectrum is the spectrum divided by countries and regions that can be used for radio device communications. The unlicensed spectrum is generally considered as a shared spectrum, that is, the communication device can use the unlicensed spectrum as long as the regulatory requirements set by the country or region on this spectrum is met, without applying for an exclusive spectrum authorization from the exclusive spectrum management agency of the country or region. Since the requirements of specific laws and regulations in each country and region should be met when using the unlicensed spectrum, for example, the communication device uses the unlicensed spectrum according to the principle of “Listen Before Talk (LBT)”. Therefore, the NR technology should be enhanced accordingly to meet the regulatory requirements of the unlicensed frequency bands, and can efficiently use the unlicensed spectrum to provide services. In the 3GPP R16 standard, the standardization of the NR-U technology in the following aspects is completed: a channel monitoring process; an initial access procedure; Control channel design; Hybrid Automatic Repeat reQuest (HARQ) and scheduling; Scheduling-free authorization transmission, etc.

### 10. Channel Monitoring: LBT

In order to allow various communication systems that use the unlicensed spectrum for wireless communication to coexist friendly on the spectrum, some countries or regions stipulate the regulatory requirements that must be met when using the unlicensed spectrum. For example, according to European regulations, the communication device follows the “LBT” principle when using unlicensed spectrum for communication, that is, the communication device needs to perform LBT or channel monitoring, before using the channel on the unlicensed spectrum for signal transmission. Only when the channel monitoring result indicates that the channel is idle or the LBT is successful, the communication device can transmit a signal through the channel. If the channel listening result of the communication device on the channel indicates that the channel is busy or the LBT fails, the communication device cannot transmit a signal over the channel. Further, in order to ensure usage fairness of spectrum resources of the shared spectrum, a time length in which the communication device may perform communication transmission on the channel does not exceed a certain period of time if the LBT performed by the communication device on the channel of the unlicensed spectrum is successful. By limiting the maximum communication time length after the successful LBT in the mechanism, different communication devices may have the opportunity to access the shared channel, so that different communication systems can coexist friendly on the shared spectrum.

Although channel monitoring is not a global regulation, the channel monitoring must be supported by the communication device in the NR system on the unlicensed spectrum in the design process of the NR system because the channel monitoring can bring the benefits of interference avoidance and friendly coexistence between communication transmission of the communication systems on the shared spectrum. From the perspective of system network layout, the channel monitoring includes two mechanisms, one is LBT of Load Based Equipment (LBE), which is also known as dynamic channel monitoring or dynamic channel occupancy, and the other is LBT of Frame Based Equipment (FBE), which is also known as semi-static channel monitoring or semi-static channel occupancy.

### 11. Dynamic Channel Monitoring

The dynamic channel monitoring may also be regarded as an LBE-based LBT mode, and the channel monitoring principle is that the communication device performs LBT on the carrier wave in the unlicensed spectrum after the service arrives, and starts transmitting a signal on the carrier wave after the LBT is successful. The LBT mode of dynamic channel monitoring includes a Type1 channel access mode and a Type2 channel access mode. The Type1 channel access mode is multi-slot channel detection of random backoff based on contention window size adjustment, and a Channel Access Priority Class (CAPC) p may be selected according to the priority of a service to be transmitted. The Type2 channel access mode is a channel access mode based on a fixed-length monitoring time slot. The Type2 channel access mode includes a Type2A channel access, a Type2B channel access, and a Type2C channel access. The Type1 channel access mode is mainly used by the communication device to initiate channel occupancy, and the Type2 channel access mode is mainly used by the communication device to share channel occupancy. In a special case, when the base station initiates channel occupancy for transmitting a Synchronization Signal/Physical Broadcast Channel (SS/PBCH) block in a Discover Reference Symbol (DRS) window and the DRS window does not include unicast data transmission of the UE, the base station may use Type2A channel access to initiate channel occupancy if the length of the DRS window does not exceed 1 ms and the duty cycle of transmission in the DRS window does not exceed 1/20.

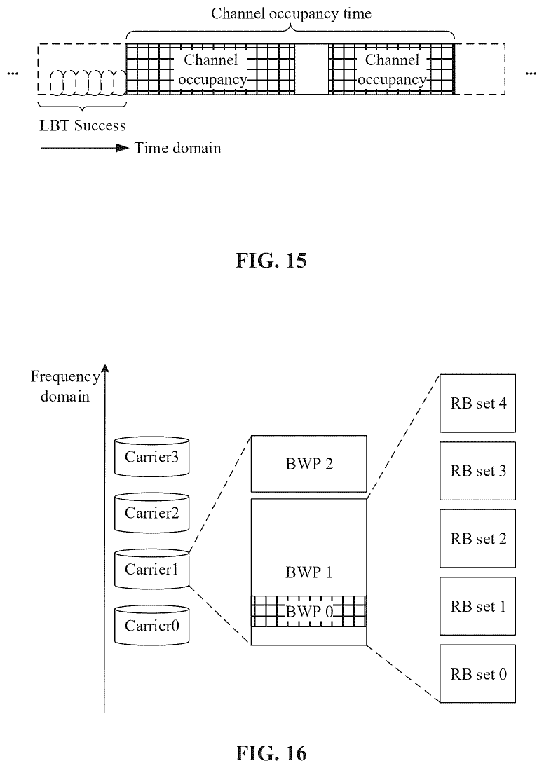

FIG. 15 shows an example of a channel occupancy time obtained by a communication device after successful LBT on a channel of an unlicensed spectrum and a signal transmission using resources within the channel occupancy time.

### 12. Default Channel Access Mode on the Base Station Side: Type1 Channel Access

Taking a base station as an example, the channel access parameters corresponding to the channel access priority class p on the base station side are shown in Table 3. In Table 3, mₚ denotes the number of backoff time slots corresponding to the channel access priority class p, CWp denotes the Contention Window (CW) size corresponding to the channel access priority class p, CW_{min, p} denotes the minimum value of the CWₚ corresponding to the channel access priority class p, CW_{max, p} denotes the maximum value of the CWₚ corresponding to the channel access priority class p, and T_{meot, p} denotes the maximum channel occupation time length corresponding to the channel access priority class p.

If the channel access procedure ends, the base station may use the channel for transmission of the service to be transmitted. The maximum length of time in which the base station can perform transmission using the channel cannot exceed T_{mcot, p}.

TABLE 3
Channel access parameters corresponding to
different channel access priorities class p

| Channel | | | | | |
|---|---|---|---|---|---|
| access | | | | | |
| priority | | | | | Allowable |
| class (p) | mₚ | CW_{min, p} | CW_{max, p} | T_{mcot, p} | CWₚ value |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63 } |
| 4 | 7 | 15 | 1023 | 8 or 10 ms | {15, 31, 63, 127, |
| | | | | | 255, 511, 1023} |

### 13. Channel Occupancy Time Sharing on the Base Station Side

When the base station initiates the Channel Occupancy Time (COT), the base station may not only use the resources in the COT for downlink transmission, but also share the resources in the COT with the UE for uplink transmission. When the resources in the COT are shared with the UE for uplink transmission, the channel access mode that the UE can use is Type2A channel access, Type2B channel access, or Type2C channel access. The Type2A channel access, Type2B channel access, and Type2C channel access are all channel access modes based on fixed-length monitoring time slots.

In the Type2A channel access, the channel detection mode of the UE is 25 us single-slot channel detection. Specifically, under the Type2A channel access, the UE can perform channel monitoring for 25 μs before starting transmission, and perform transmission after the channel monitoring is successful.

In the Type2B channel access, the channel detection mode of the UE is 16 us single-slot channel detection. Specifically, under the Type2B channel access, the UE can perform channel monitoring for 16 μs before starting transmission, and perform transmission after the channel monitoring is successful. An interval between the starting position of the transmission and the ending position of the previous transmission is 16 μs.

In the Type2C channel access, the UE performs transmission without performing channel detection after the end of the interval. Specifically, under the Type2C channel access, the UE can directly perform transmission, and an interval between the starting position of the transmission and the ending position of the previous transmission is less than or equal to 16 μs, and the length of the transmission does not exceed 584 μs.

### 14. Channel Access Parameter Indication (Including Cyclic Prefix Extension (CPE))

In the NR-U system, when the UE is scheduled to perform a Physical Uplink Shared Channel (PUSCH) or a Physical Uplink Control Channel (PUCCH) transmission, the base station may indicate a channel access mode corresponding to the PUSCH or the PUCCH by carrying Downlink Control Information (DCI) of an uplink grant (UL grant) or a downlink grant (DL grant). Since some channel access modes should meet the requirements about the interval of 16 μs or 25 μs, the UE may ensure the interval between two transmissions by transmitting an extended cyclic prefix (CPE), and accordingly, the base station may indicate the CPE length of the first symbol of the uplink transmission of the UE.

In the specific indication, the base station may explicitly indicate the CPE length, the channel access mode, the channel access priority class and other channel access parameters to the UE by joint coding. The characteristics of the indication mode of channel access parameters introduced in different DCI formats are introduced below.

### 1) Fallback Uplink Grant for Scheduling PUSCH Transmission (DCI Format 0_0)

A set of joint indications of the channel access mode and CPE length preset in the standard is shown in Table 4. The fallback uplink grant includes 2-bit LBT indication information for indicating the channel access mode and the CPE length which are coded jointly from the set shown in Table 4. The channel access mode and the CPE length are used for PUSCH transmission. If the channel access mode is Type1 channel access, the UE selects the channel access priority CAPC according to the service priority.

### 2) Fallback Downlink Grant for Scheduling PDSCH Transmission (DCI Format 1_0)

A set of joint indications of the channel access mode and the CPE length preset in the standard is shown in Table 4. The fallback downlink grant includes 2-bit LBT indication information for indicating the channel access mode and the CPE length which are coded jointly from the set shown in Table 4. The channel access mode and the CPE length are used for PUCCH transmission, and the PUCCH may carry an ACKnowledge (ACK) or a Negative ACKnowledge (NACK) corresponding to the PDSCH. If the channel access mode is Type1 channel access, the UE determines a channel access priority CAPC=1 for transmitting the PUCCH.

TABLE 4
Set of Joint Indication of Channel Access Mode and CPE Length

| LBT | | |
|---|---|---|
| indication | Channel access mode | CPE Length |
| 0 | Type2C Channel access | C2*Symbol length-16 μs-TA |
| 1 | Type2A Channel access | C3*Symbol length-25 μs-TA |
| 2 | Type2A Channel access | C1*Symbol length-25 μs |
| 3 | Type1 Channel access | 0 |

In Table 4, the value of C1 is specified by the protocol. C1=1 when the subcarrier spacing is 15 kHz and 30 kHz, and C1=2 when the subcarrier spacing is 60 kHz. The values of C2 and C3 are configured by a high layer parameter. The values of C2 and C3 range from 1 to 28 when the subcarrier spacing is 15 kHz and 30 kHz, and the values of C2 and C3 range from 2 to 28 when the subcarrier spacing is 60 kHz.

### 3) Non-Fallback Uplink Grant for Scheduling PUSCH Transmission (DCI Format 0_1):

An LBT parameter indication set is configured by a high layer, and the LBT parameter indication set includes at least one jointly coded channel access mode, CPE length and CAPC. The non-fallback uplink grant includes LBT indication information for indicating the jointly coded channel access mode, CPE length and CAPC from the LBT parameter indication set. This channel access mode, the CPE length and the CAPC are used for PUSCH transmission. If the indicated channel access mode is Type2 channel access, the indicated CAPC is the CAPC used when the base station obtains the COT. The LBT indication information includes at most 6 bits.

### 4) Non-Fallback Downlink Grant for Scheduling PDSCH Transmission (DCI Format 1_1):

An LBT parameter indication set is configured by a high layer, and the LBT parameter indication set includes at least one jointly coded channel access mode and CPE length. The non-fallback downlink grant includes LBT indication information for indicating the jointly coded channel access mode and the CPE length from the LBT parameter indication set. The channel access mode and the CPE length are used for PUCCH transmission, and the PUCCH may carry ACK or NACK information corresponding to the PDSCH. If the channel access mode is Type1 channel access, the UE determines a channel access priority CAPC=1 for transmitting the PUCCH. The LBT indication information includes at most 4 bits.

In addition to the above-described explicit indication, the base station may also implicitly indicate the channel access mode within the COT. When the UE receives the UL grant or DL grant transmitted by the base station indicating that the channel access type corresponding to the PUSCH or PUCCH is Type1 channel access, the UE may update the channel access type corresponding to the PUSCH or PUCCH to be Type2A channel access instead of the Type1 channel access if the UE may determine that the PUSCH or PUCCH belongs to the COT of the base station, for example, the UE receives the DCI format 2_0 transmitted by the base station and determines that the PUSCH or PUCCH belongs to the COT of the base station according to the DCI format 2_0.

### 15. Frequency Domain Resource Division of Sidelink

The frequency domain resource division of the sidelink is similar to that of Uu. As shown in FIG. 16. When the frequency domain resource has multiple carriers, the terminal and the system should support carrier aggregation, and the system may also support only a single carrier scenario and carrier aggregation is not required in this case. The frequency resources of a carrier can be divided into one or more bandwidth parts (BWPs). When there are multiple BWPs in the frequency domain, only one BWP is activated each time, and the SL system only supports one side bandwidth part (SL BWP). In the NR-U (unlicensed band) system, a BWP is divided into multiple RB sets, each of which is 20 MHz in size, and one RB set is the smallest unit of the LBT. For example, in FIG. 16, BWP 1 is divided into RB set 0 to RB set 4.

### 16. S-SSB Time Domain Resource Allocation

In the scenario including the NR V2X and sidelink, a time-domain resource allocation for the S-SSB is taken a time slot as the minimum granularity for transmission, and the period is 160 ms. The number of S-SSB time slots in the period is different based on different subcarrier spacing. For example, the number of S-SSB slots in one period corresponding to the SCS of 15 kHz is 1, the number of S-SSB slots in one period corresponding to the SCS of 30 kHz may be configured to be a parameter {1, 2}, and the number of S-SSB slots in one period corresponding to the SCS of 60 kHz may be configured to be a parameter {1, 2, 4}, and the like.

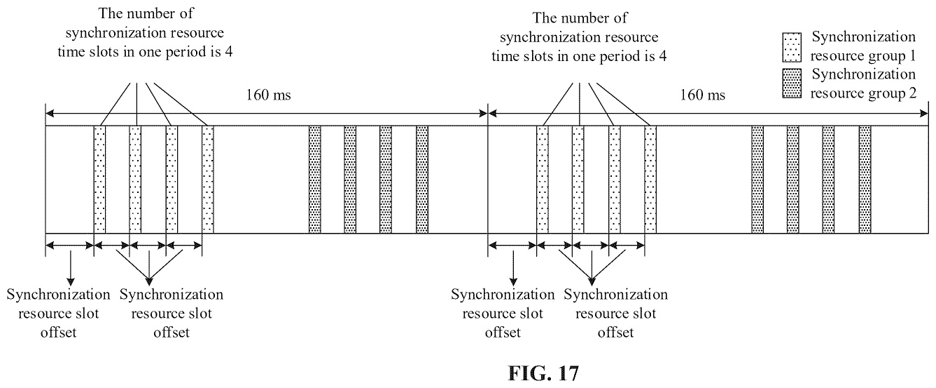

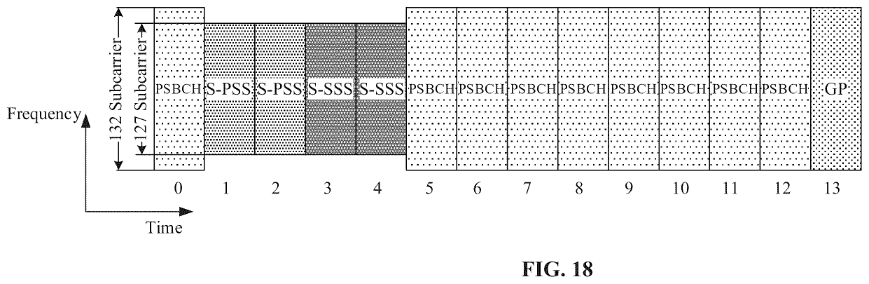

FIG. 17 is a schematic diagram illustrating an example of an S-SSB time domain resource configuration. FIG. 17 shows two sets of S-SSBs (that is, two sets of synchronization resource groups, including synchronization resource group 1 and synchronization resource group 2 shown in FIG. 17) in one period, and each set of S-SSBs includes four S-SSB time slots (that is, synchronization resource time slots), one set of S-SSBs is used for transmitting and the other set of S-SSBs is used for receiving. For convenience of explanation, the design in the embodiment of the present disclosure takes one set of S-SSBs as an example of a basic design idea. FIG. 18 shows a time-frequency structure diagram of the S-SSB. One S-SSB slot includes 14 OFDM symbols and is composed of PSBCH, S-PSS, and S-SSS. In the frequency domain, the PSBCH occupies 132 subcarriers, and the Sidelink Primary Synchronization Signal (S-PSS) and Sidelink Secondary Synchronization Signal (S-SSS) sequences occupy 127 subcarriers.

### 17. S-SSB Time-Frequency Domain Mapping

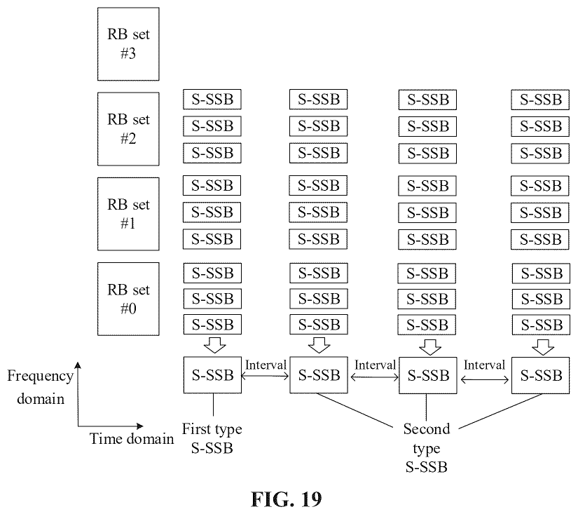

According to the conclusion of the current R18 SL technology, the mapping of S-SSB in the time-frequency domain is shown in FIG. 19. One S-SSB period (160 ms) includes a first-type S-SSB and a second-type S-SSB. The first-type S-SSB is S-SSB slot resources configured by R16/R17 SL, and the second-type S-SSB is additional S-SSB slot resources newly defined by R18. In the frequency domain resources corresponding to one S-SSB slot, the UE may attempt to map/transmit the S-SSB on one or more of four RB sets if the four RB sets are included in the frequency domain. Here, the attempt here means that the UE performs LBT on a RB set first, and the UE maps/transmits the S-SSB on the RB set if it is detected that the RB set is not occupied/available, and the UE performs LBT on multiple RB sets respectively if the multiple RB sets are used for transmission, and determines whether the S-SSB can be transmitted on each RB set according to a LBT result on the RB set. Within the RB set, the S-SSBs are repeatedly mapped in the frequency domain. On the multiple RB sets corresponding to one time slot, the S-SSB is also repeated within each RB set.

In addition, according to the current conclusion, each S-SSB slot of R16/R17 corresponds to K additional S-SSB slots, and an interval between the S-SSB slots is configured or preconfigured.

The related technologies/terms related to the embodiments of the present disclosure have been briefly described above, and are not described repeatedly in the following embodiments.

It should be understood that the terms “system” and “network” are often used interchangeably herein. Herein, the term “and/or” is only an association relationship describing association objects, and means that there may be three relationships, for example, A and/or B may mean that A alone exists, A and B simultaneously exist, and B alone exists. In addition, the character “/” herein generally indicates that the related objects before and after are in an “or” relationship. It should also be understood that the “indication” mentioned in the embodiments of the present disclosure may be a direct indication, an indirect indication, or an associated relationship. For example, A indicates B, which may mean that A directly indicates B, for example, B can be acquired by A, or that A indicates B indirectly, for example, A indicates C, and B can be obtained through C, or that there is an association relationship between A and B. It should also be understood that “correspondence” mentioned in the embodiments of the present disclosure may indicate that there is a direct correspondence or indirect correspondence between the two objects, may indicate that there is a correlation relationship between the two objects, or may indicate a relationship between indicating and being indicated, configuring and being configured, or the like. It should also be understood that the terms “predefined” or “predefined rules” mentioned in the embodiments of the present disclosure may be implemented by storing corresponding codes or tables in advance in the device (e.g., including the terminal devices and the network device) or in other ways used to indicate relevant information, and specific implementations thereof is not limited in the present disclosure. For example, the term “predefined” may refer to being defined in the protocol. It should also be understood that in the embodiment of the present disclosure, the “protocol” may refer to a standard protocol in the communication field, and may include, for example, an LTE protocol, an NR protocol and related protocols applied to the future communication system, which is not limited in the present disclosure.

It should also be understood that the specific form of the terminal is not limited in the embodiments of the present disclosure. As an example, the terminal in the embodiment of the present disclosure may refer to an access terminal, a User Equipment (UE), a user unit, a user station, a mobile station, a mobile terminal, a remote station, a remote terminal, a mobile device, a user terminal, a terminal device, a wireless communication device, a user agent, or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device having a wireless communication functionality, a computing device or other processing device connected to a wireless modem, a vehicle-mounted device, a wearable device, a terminal device in the 5G network or a terminal device in the future evolution network, or the like.

In the current SL technology, in the frequency domain, the S-SSB may be repeated multiple times in one RB set, and the S-SSB may be repeated multiple times in multiple sets of RBs. In the time domain, the transmission granularity of the S-SSB is one time slot (including 14 OFDM symbols-a regular Cyclic Prefix (CP)). When the terminal transmits an S-SSB on a time slot, the steps of power control are described as follows.

1) The following frequency domain resources on which the S-SSBs is to be transmitted are determined: for example, the RB sets occupied in the frequency domain; the number of repetitions (or repetitive S-SBBs) of the S-SSB transmitted on each RB set; and an interval between adjacent S-SSBs within one RB set.

2) Power control/power allocation: the total transmit power (maximum available transmit power) is P_{CMAX}. During the power control/power allocation, a part of the power P′ is evenly allocated to the S-SSB on the anchor RB set first, and then the remaining power P″ is evenly distributed to the S-SSB on the non-anchor RB set. When P′=P_{CMAX}, all the power is allocated to the S-SSB on the anchor RB set, and no power is allocated to the S-SSB on the non-anchor RB set, that is, no S-SSB is transmitted. When P″ takes the maximum value, the S-SSBs on all RB sets (anchor RB sets and non-anchor RB sets) are allocated with the same power, that is, the total transmit power is equally distributed to all the S-SSBs in the frequency domain.

3) Channel access/multiple channel access: a channel access mechanism (that is, channel monitoring LBT) is required before the time slot for sending the S-SSB. In this process, LBT is performed respectively in units of each RB set. As an example, the channel access mechanism may include downlink-like channel access and uplink-like channel access.

In the downlink-like channel access, LBT is performed on N RB sets respectively, and if the channel access for any RB set is successful, the S-SSB can be transmitted on the RB set, and if channel access for any RB set fails, no S-SSB is transmitted on that RB set.

In the uplink-like channel access, LBT is performed on N RB sets respectively, and if channel access for any RB set fails, no S-SSB is transmitted on any of the N RB sets, and if channel access for all N RB sets is successful, the S-SSB is transmitted on the N RB sets.

4) According to the channel access result, the S-SSB is transmitted in the current time slot based on the above power allocation.

Since the S-SSB can be repeated multiple times in one RB set, transmitting the S-SSB on a RB set in the embodiment of the present disclosure may also be understood as transmitting multiple repetitive S-SSBs on the RB set.

According to the above technical solution, it is necessary to first determine the RB set which is to transmit the S-SSB and the number of repetitions of the S-SSB in each RB set, perform power allocation, and then perform channel access and determine the RB set which can transmit the S-SSB according to the channel access result. The channel access result determines the RB set that can transmit the S-SSB, and the RB set that can transmit the S-SSB may be different from the RB set that is determined in advance to transmit the S-SSB, because a part of RB sets cannot transmit the S-SSB due to failure of the channel access. Therefore, the S-SSB transmit power allocated to the part of RB sets is wasted. In addition, if the S-SSB is transmitted only on the RB sets for which channel access is successful, the sum of the S-SSB transmit powers allocated in advance on the RB sets for which channel access is successful may be less than the maximum available transmit power P_{CMAX}, which results in a low total power of the current time slot for transmission of the S-SSB, and thus affects the synchronization effect of the SL.

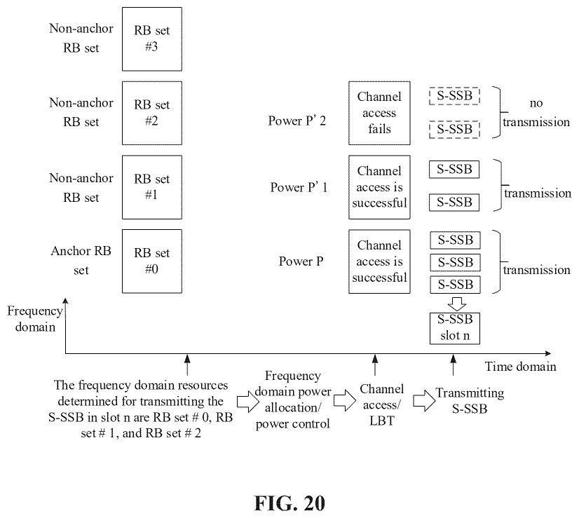

As shown in FIG. 20, assuming that the frequency domain resources determined to transmit the S-SSB in slot n (S-SSB slot n) includes RB set #0, RB set #1, and RB set #2, power control/power allocation may be performed in advance in the frequency domain, that is, the maximum available transmit power P_{CMAX} may be allocated to the S-SSBs on RB set #0, RB set #1 and RB set #2. For example, in FIG. 20, the powers allocated to the S-SSBs on RB set #0, RB set #1 and RB set #2 are P′, P′1, and P′2, respectively. However, since the channel access fails on the RB set #2, the S-SSB can be transmitted according to the determined/allocated power only on the RB set #0 and the RB set #1 in which the channel access is successful, and no S-SSB is transmitted on the RB set #2. In this case, the total power (i.e. P′+P′1) of transmitting the S-SSB on the time slot n is less than the maximum available transmit power P_{CMAX}, thereby affecting the synchronization effect of the SL.

In view of this, the present disclosure provides a method and device for controlling a synchronization signal transmit power, a terminal, a chip, and a storage medium. The method may be executed by for example a terminal, or may be executed by a chip, a chip system or a circuit disposed in the terminal, which is not limited in the embodiments of the present disclosure. For convenience of description, description will be made below taking the terminal as an execution entity.

In the method, the terminal may perform channel access on at least one first RB set, and a first S-SSB transmit power on the at least one first RB set is determined based on a channel access result of the at least one first RB set. Since the channel access result of the at least one first RB set is taken into account when determining/allocating the first S-SSB transmit power for the at least one first RB set, the S-SSB transmit power is avoided from being allocated to the first RB set in which channel access fails, thereby avoiding power waste.

In order to facilitate understanding of the technical solutions of the embodiments of the present disclosure, the technical solutions of the present disclosure will be described in detail below by specific embodiments. The above related technologies can be as an optional solution arbitrarily combined with the technical solutions of the embodiments of the present disclosure, and all of them belong to the scope of protection of the embodiments of the present disclosure. The embodiments of the present disclosure include at least some of the following.

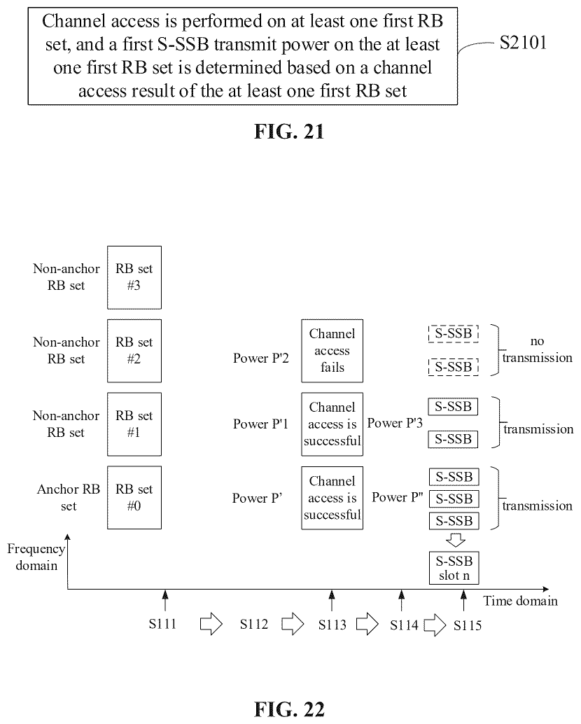

FIG. 21 is a schematic flowchart of a method for controlling a synchronization signal transmit power according to an embodiment of the present disclosure. As shown in FIG. 21, the method may include the following operation S2101.

At S2101, channel access is performed on at least one first RB set. A first S-SSB transmit power on the at least one first RB set is determined based on a channel access result of the at least one first RB set.

The operation that channel access is performed on the at least one first RB set may also be understood that the channel access is performed in each of the at least one first RB set. For example, assuming that at least one first RB set includes the first RB set #1 and the first RB set #2, channel access may be performed in the first RB set #1 and the first RB set #2, respectively. In an embodiment of the present disclosure, performing channel access may be replaced with performing LBT.

The operation that the first S-SSB transmit power on the at least one first RB set is determined may be further understood as an operation that the first S-SSB transmit power on each of the at least one first RB set is determined, or may also be understood as an operation that the first S-SSB transmit power allocated to each of the at least one first RB set is determined. The first S-SSB transmit power allocated to the first RB set may be or may not be 0.

In the embodiment of the present disclosure, the S-SSB transmit power (for example, the first S-SSB transmit power) on the RB set (for example, the first RB set) may also be understood as a power which is allocated to the RB set and used for transmitting the S-SSB on the RB set, or may also be understood as power/transmit power allocated to the S-SSB on the RB set.

Since the S-SSB is repeatedly mapped in the frequency domain within one RB set, the power/transmit power allocated to the S-SSB on the RB set is the total power/total transmit power allocated to all repeatedly mapped S-SSBs on the RB set.

In some embodiments, the sum of the first S-SSB transmit powers on a first RB set (i.e., the first RB set for which the channel access is successful) for which the channel access result indicates success in the at least one first RB set is the maximum available transmit power (e.g., denoted as P_{CMAX}). Here, the maximum available transmit power can also be understood as the total transmit power or the maximum transmit power available to the terminal. That is, the terminal may allocate the maximum available transmit power to the first RB set for which the channel access result indicates success, and accordingly, the first S-SSB transmit power allocated to the first RB set for which channel access result indicates failure (that is, the first RB set for which channel access is failed) is 0.

For example, assuming that the at least one first RB set includes the first RB set #1, the first RB set #2, and the first RB set #3, and if the channel access results of the first RB set #1 and the first RB set #2 indicate success, and the channel access result of the first RB set #3 indicates failure, the sum of the first S-SSB transmit power on the first RB set #1 and the first RB set #2 is P_{CMAX}. For example, if the first S-SSB transmit power on the first RB set #1 is P₁₁, and the first S-SSB transmit power on the first RB set #2 is P₁₂, P₁₁+P₁₂=P_{CMAX}.

In a possible manner, the same power/transmit power is allocated by the terminal to all the S-SSB on each first RB set for which channel access is successful. In another possible manner, in a case where the first RB set for which channel access is successful includes an anchor RB set, the first S-SSB transmit power allocated by the terminal to the anchor RB set is larger than the first S-SSB transmit power allocated to other first RB set for which channel access is successful.

According to the above-described technical solution, since the sum of the first S-SSB transmit powers allocated to all the first RB sets for which channel access is successful is the maximum available transmit power, it can ensure that the transmit power is used for transmitting the S-SSB to the maximum extent, thereby ensuring the transmission/detection effect of the S-SSB.

In some embodiments, the at least one first RB set includes an anchor RB set. The first RB set for which the channel access result indicates success includes an anchor RB set, or the first RB set for which the channel access result indicates success does not include the anchor RB set.

In an example, the first RB set for which the channel access result indicates success includes the anchor RB set. That is, if the channel access of the anchor RB set is successful, the terminal may allocate the maximum available transmit power P_{CMAX} to all the first RB sets, for which channel access is successful, including the anchor RB set.

As another example, the first RB set for which the channel access result indicates success does not include the anchor RB set. That is, if the channel access of the anchor RB set fails, the terminal may allocate the maximum available transmit power P_{CMAX} to all the first RB sets for which the channel access result indicates success.

According to the above technical solution, regardless of whether the channel access result of the anchor RB set is successful or not, the terminal can allocate the maximum available transmit power to the first RB set for which the channel access result indicates success. In this way, the terminal can transmit the S-SSB according to the maximum available transmit power even when the channel access of the anchor RB set fails, and the transmitted S-SSB may be received by some terminal with strong capabilities. The terminal with strong capability may also be understood as a terminal capable of receiving the S-SSB on the RB set other than the anchor RB set.

In some embodiments, the at least one first RB set include the anchor RB set. When the channel access result of the anchor RB set indicates failure, the first S-SSB transmit power on the at least one first RB set is 0. That is, if the channel access of the anchor RB set fails, the first S-SSB transmit power on all the first RB sets is 0, that is, the S-SSB is not transmitted on all the first RB sets.

In some scenarios, the device which communicates with the terminal may be a terminal with weak capability, and the terminal with weak capability may not be able to receive the S-SSB on the RB set other than the anchor RB set. Therefore, if the channel access of the anchor RB set fails, the terminal may not need to transmit the S-SSB on the at least one first RB set to save energy consumption.

According to the above technical solution, the terminal may perform channel access on at least one first RB set, and the channel access result on the at least one first RB set may be used to determine the first S-SSB transmit power on the at least one first RB set. Since the channel access result of the at least one first RB set is taken into account when determining/allocating the first S-SSB transmit power for the at least one first RB set, thereby avoiding allocating the S-SSB transmit power to the first RB set for which channel access fails, and thus avoiding power waste.

In some embodiments, before at least one first RB set perform channel access, the method further includes: determining a second S-SSB transmit power on the at least one first RB set. The sum of the second S-SSB transmit powers on the at least one first RB set is the maximum available transmit power.

The operation of determining the second S-SSB transmit power on the at least one first RB set may be further understood as determining a second S-SSB transmit power on each of the at least one first RB set, or may be further understood as determining a second S-SSB transmit power allocated to each of the at least one first RB set.

For example, assuming that the at least one first RB set includes the first RB set #1 and the first RB set #2, and before the at least one first RB set performs channel access, it may be determined that the second S-SSB transmit power on the first RB set #1 is P₂₁, the second S-SSB transmit power on the first RB set #2 is P₂₂, and P₂₁+P₂₂=P_{CMAX}.

In some embodiments, when the channel access result of each of the at least one first RB set is successful, the first S-SSB transmit power on each first RB set is the same as the second S-SSB transmit power on the respective first RB set.

That is, if the channel access of all the first RB set is successful, the first S-SSB transmit power allocated to each first RB set is the same as the second S-SSB transmit power allocated to the respective first RB sets before the channel access is performed. For example, assuming that at least one first RB set includes the first RB set #1 and the first RB set #2, and if it is determined before the first RB set #1 and the first RB set #2 perform channel access that the second S-SSB transmit power on the first RB set #1 is P₂₁ and the second S-SSB transmit power on the first RB set #2 is P₂₂, the first S-SSB transmit power on the first RB set #1 is the same as P₂₁, and the first S-SSB transmit power on the first RB set #2 is the same as P₂².

In some embodiments, the at least one first RB set includes the anchor RB. When the channel access result of the anchor RB set indicates success, the first S-SSB transmit power on the anchor RB set is the same as or different from the second S-SSB transmit power on the anchor RB set. That is, when the channel access of the anchor RB set is successful, the first S-SSB transmit power allocated to the anchor RB set may be the same as or different from the second S-SSB transmit power allocated to the anchor RB set before the channel access is performed.

In some embodiments, the at least one first RB set may be a frequency domain resource (RB set) for transmitting the S-SSB determined before performing channel access. The frequency domain resource for transmitting the S-SSB determined before performing the channel access may also be understood as a frequency domain resource which is to transmit the S-SSB in a certain time slot (for example, time slot n) determined by the terminal before performing the channel access. That is, the terminal may determine/decide in advance that the frequency domain resource to be used for transmitting the S-SSB includes at least one first RB set, and perform a channel on the at least one first RB set, and determine the first S-SSB transmit power on the at least one first RB set according to the channel access result of the at least one first RB set.

According to the above technical solution, when the terminal has determined an S-SSB transmit power (that is, the second S-SSB transmit power) on the at least one first RB set before the at least one first RB set performs channel access, the terminal may re-determine/allocate an S-SSB transmit power (that is, the first S-SSB transmit power) on the at least one first RB set according to the channel access result of the at least one first RB set after the terminal performs channel access, to avoid allocating the S-SSB transmit power to the first RB set for which channel access fails. Furthermore, in some scenarios, the allocated power that cannot be used since channel access fails can be reallocated and reused for transmitting the S-SSB on the first RB set for which channel access is successful, so that the transmit power can be used to the maximum extent, and the transmission/detection effect of the synchronization signal can be ensured.

In some embodiments, the method may further include: obtaining configuration information of a COT. The configuration information of the COT is used to configure at least one second RB set included in the COT. That is, the terminal may acquire at least one second RB set included in the COT based on the configuration information of the COT.

The configuration information of the COT may be determined, for example, by the terminal. Alternatively, the configuration information of the COT may come from another terminal.

For example, if the COT is initiated by the terminal, the configuration information of the COT may be determined by the terminal. In another example, if the COT is shared to the terminal by another terminal, the configuration information of the COT may come from the other terminal.

In some embodiments, the at least one first RB set may include at least one third RB set and the at least one second RB set. The third RB set is a frequency domain resource (RB set) for transmitting the S-SSB which is determined before performing channel access.

The at least one first RB set includes at least one third RB set and the at least one second RB set, and it may be understood that the at least one first RB set is a union set composed of the at least one third RB set and the at least one second RB set. For example, assuming that at least one second RB set (included in the COT) includes RB set #1 and RB set #2, and at least one third RB set (the frequency domain resource for transmitting the S-SSB which is determined before performing channel access) includes RB set #2 and RB set #3, the at least one first RB set may include RB set #1, RB set #2, and RB set #3.

In a first possible manner, the at least one third RB set includes at least one second RB set. That is, at least one second RB set is a subset of at least one third RB set. For example, at least one third RB set includes RB set #1 and RB set #2, and at least one second RB set includes RB set #2.

In a second possible manner, the at least one third RB set does not include the at least one second RB set. That is, there is no overlap between the at least one third RB set and the at least one second RB set. For example, the at least one third RB set includes RB set #1, and the at least one second RB set includes RB set #2 and RB set #3.

In a third possible manner, the at least one third RB set has a part of RB sets which are identical to the at least one second RB set. That is, there is a partial overlap between the at least one third RB set and the at least one second RB set. For example, at least one third RB set includes RB set #1 and RB set #2, and at least one second RB set includes RB set #2 and RB set #3.

According to the method of the present embodiment, after acquiring the at least one second RB set included in the COT, the terminal may take the union set composed of the at least one second RB set and the at least one third RB set as the at least one first RB set, further execute a channel on the at least one first RB set, and determine the first S-SSB transmit power on the at least one first RB set according to the channel access result of the at least one first RB set. That is, the terminal may allocate the first S-SSB transmit power to a third RB set, for which channel access is successful, in at least one third RB set determined before performing the channel access, and may allocate the first S-SSB transmit power to a second RB set, for which channel access is successful, in at least one second RB set included in the COT. In this case, the terminal may transmit the S-SSB on the second RB set for which channel access is successful in at least one second RB set included in the COT, so that the resources in COT can be continuously occupied and maintained, thereby avoiding preempting the resources in COT by a user in other system.

In some embodiments, in a case where the at least one first RB set includes the at least one third RB set and the at least one second RB set described above, the method may further include: determining a third S-SSB transmit power on the at least one first RB set in a case where channel access is not completed. The sum of the third S-SSB transmit powers on the at least one first RB set is the maximum available transmit power.

Here, the channel access is not completed, which may mean that the channel access has not started, or the channel access is being performed and has not ended.

The operation of determining the third S-SSB transmit power on the at least one first RB set may be further understood as determining the third S-SSB transmit power on each of the at least one first RB set, or may also be understood as determining the third S-SSB transmit power allocated to each of the at least one first RB set.

For example, assuming that at least one second RB set includes RB set #1 and RB set #2, and at least one third RB set includes RB set #2 and RB set #3, the at least one first RB set may include RB set #1, RB set #2, and RB set #3. In this case, before the terminal performs channel access on the RB set #1, the RB set #2, and the RB set #3, or during a process that the terminal performs channel access by the RB set #1, the RB set #2 and the RB set #3, the terminal may allocate the third S-SSB transmit power to each of the RB set #1, the RB set #2, and the RB set #3, and the sum of the third S-SSB transmit powers allocated to all of the RB sets is the maximum available transmit power P_{CMAX}.

In some embodiments, the at least one first RB set includes an anchor RB set. When the channel access result of the anchor RB set indicates success, the first S-SSB transmit power on the anchor RB set is the same or different from the third S-SSB transmit power on the anchor RB set.

That is, if the terminal determines the third S-SSB transmit power on at least one first RB set when the channel access is not completed, and if the channel access result of the anchor RB set in the at least one first RB set indicates success after the channel access is completed, the first S-SSB transmit power allocated to the anchor RB set may be the same as or different from the third S-SSB transmit power allocated by the terminal to the anchor RB set in a case that the channel access is not completed.

In some embodiments, before acquiring configuration information of the COT, the method may further include: determining a fourth S-SSB transmit power on at least one third RB set. The sum of the fourth S-SSB transmit powers on the at least one third RB set is the maximum available transmit power.

The operation that determining the fourth S-SSB transmit power on the at least one third RB set may also be understood as determining a fourth S-SSB transmit power on each third RB set in the at least one third RB set, or may also be understood as determining a fourth S-SSB transmit power allocated to each third RB set in the at least one third RB set.

That is, before the terminal acquires the at least one second RB set included in the COT, the terminal may allocate a fourth S-SSB transmit power to each third RB set of the determined at least one third RB set to be used to transmit the S-SSB, and the sum of the fourth S-SSB transmit powers allocated to all the third RB set is the maximum available transmit power P_{CMAX}.

In some embodiments, the at least one third RB set includes an anchor RB set. When the channel access result of the anchor RB set indicates success, the first S-SSB transmit power on the anchor RB set is the same as or different from the fourth S-SSB transmit power on the anchor RB set. That is, when channel access of the anchor RB set is successful, the first S-SSB transmit power allocated to the anchor RB set may be the same as or different from the fourth S-SSB transmit power allocated to the anchor RB set before acquiring the configuration information of the COT.

In some embodiments, the method may further include: determining a third S-SSB transmit power on at least one first RB set in a case that the channel access is not complete; The sum of third S-SSB transmit powers on the at least one first RB set is a maximum available transmit power. In some embodiments, the at least one third RB set includes an anchor RB set. The third S-SSB transmit power on the anchor RB set is the same as or different from the fourth S-SSB transmit power on the anchor RB set. When the channel access result of the anchor RB set indicates success, the first S-SSB transmit power on the anchor RB set is the same or different from the third S-SSB transmit power on the anchor RB set.

That is, the third S-SSB transmit power allocated to the anchor RB set when the channel access is not completed may be the same as or different from the fourth S-SSB transmit power allocated to the anchor RB set before acquiring the configuration information of the COT. When the channel access of the anchor RB set is successful, the first S-SSB transmit power allocated to the anchor RB set may be the same as or different from the third S-SSB transmit power allocated to the anchor RB set when the channel access is not completed.

In some embodiments, the method may further include, for each of the at least one first RB set, transmitting an S-SSB on the first RB set based on the first S-SSB transmit power on the first RB set in a case where the first S-SSB transmit power on the first RB set is not 0.

For example, assuming that at least one first RB set includes the first RB set #1, the first RB set #2, and the first RB set #3, and if the first S-SSB transmit power on the first RB set #1 is P₁₁ (P₁₁ is not equal to 0), the first S-SSB transmit power on the first RB set #2 is P₁₂ (P₁₂ is not equal to 0) and the first S-SSB transmit power on the first RB set #3 is 0, the terminal may transmit the S-SSB on the first RB set #1 according to P₁₁ and transmit the S-SSB on the first RB set #2 according to P₁₂. Since the first S-SSB transmit power on the first RB set #3 is 0, the terminal does not transmit the S-SSB on the first RB set #3.

In some embodiments, since the S-SSB can be repeated multiple times on one RB set, the operation of transmitting the S-SSB on the first RB set #1 according to P₁₁ may also be understood as transmitting multiple repetitive S-SSBs on the first RB set #1 according to P₁₁. The operation of transmitting the S-SSB on the first RB set #2 according to P₁₂ may also be understood as transmitting multiple repetitive S-SSBs on the first RB set #2 according to P₁₂.

According to the method of the present embodiment, the terminal may perform channel access on at least one first RB set, and the channel access result on the at least one first RB set may be used to determine the first S-SSB transmit power on the at least one first RB set, and the terminal may further transmit the S-SSB according to the first S-SSB transmit power on the at least one first RB set. Since the channel access result of the at least one first RB set is taken into account when determining/allocating the first S-SSB transmit power for the at least one first RB set, it is possible to avoid allocating the S-SSB transmit power to the first RB set for which channel access fails, thereby avoiding power waste. Further, since the sum of the first S-SSB transmit powers on the first RB set for which the channel access result indicates success is the maximum available transmit power, it is ensured that the transmit power is maximally used for transmitting the S-SSB on the first RB set for which the channel access is successful, thereby ensuring the transmission/detection effect of the S-SSB.

The method for controlling a synchronization signal transmit power provided by the embodiment of the present disclosure has been described above, and in order to facilitate understanding of the embodiment of the present disclosure, a possible implementation of the method for controlling a synchronization signal transmit power applicable to the embodiment of the present disclosure will be described below with reference to an example.

Exemplarily, possible implementations include the first solution to the fourth solution.

In the first solution, the power control/power allocation is re-adjusted according to the channel access result.

In the second solution, power allocation is not performed in advance and waits till the channel access result, and power control/power allocation is performed according to the channel access result.

In the third solution, the COT information is considered during the channel access, and then the power control/power allocation is re-adjusted according to the channel access result.

In the fourth solution, the COT information is considered during the channel access, and power allocation is not performed in advance and waits till the channel access result and power control/power allocation is performed according to the channel access result.

The above four solutions are introduced below.

### First Solution

In the first solution, the UE (terminal) may readjust the power control/power allocation according to the channel access result. The process of the first solution may include the following operations.

11) The UE decides (determines) to transmit the S-SSBs on target RB sets k₀, k₁, . . . , kₙ in the time slot n, and performs power control/power allocation on the S-SSBs on the target RB sets k₀, k₁, . . . , kₙ in the frequency domain.

12) The UE performs channel access/LBT on the RB sets k₀, k₁, . . . , kₙ.

In a possible case, if the channel access results of the RB sets k₀, k₁, . . . , kₙ all indicate success, the S-SSB is transmitted on the RB sets k₀, k₁, . . . , kₙ corresponding to the time slot n according to a predetermined power (the power allocated in operation 11)).

In another possible case, if the channel access result of a part of the RB sets k₀, k₁, . . . , kₙ indicates failure, the UE may perform power control/power allocation on the S-SSB on the RB set for which channel access is successful. There are three implementations for power reallocation.

In the first implementation, power control/power allocation is re-performed on all S-SSBs on the anchor RB set and the non-anchor RB set.

For example, assuming that the RB set for which channel access is successful includes the anchor RB set and the non-anchor RB set, the UE may reallocate the maximum available transmit power P_{CMAX} to the anchor RB set and the non-anchor RB set for which channel access is successful.

In the second implementation, the power allocated to the S-SSB on the anchor RB set remains unchanged, and the remaining power is reallocated to the S-SSB on the RB set for which channel access is successful.

For example, assuming that the anchor RB set and the non-anchor RB set are included in the RB set for which channel access is successful, the UE may not need to change the power allocated to the S-SSB on the anchor RB set when reallocating power. That is, the power allocated to the S-SSB on the anchor RB set is still the power allocated to the S-SSB on the anchor RB set in operation 11). Under the premise, the UE may allocate the remaining power to the S-SSB on the RB set for which channel access is successful other than the anchor RB set. The remaining power may be expressed as: remaining power=maximum available transmit power-power allocated to the S-SSB on the anchor RB set.

In the third implementation, if channel access of the anchor RB set fails, all transmit power (maximum available transmit power) is reallocated to the S-SSB on the RB set for which channel access is successful, or no S-SSB is transmitted on the time slot n.

For ease of understanding, FIG. 22 shows an example of the first implementation mode in the first solution. The flow illustrated in FIG. 22 may include the following operations S111 to S115.

At S111, the UE determines that frequency domain resources which are to transmit the S-SSB in slot n (S-SSB slot n) include RB set #0, RB set #1 and RB set #2, and may determine the number of repetitive S-SSBs transmitted on each RB set, and an interval between adjacent S-SSBs in one RB set or the like. The RB set #0 is an anchor RB set, and the RB set #1 and the RB set #2 are non-anchor RB sets.

At S112, the UE performs frequency domain power allocation/power control.

In this operation, the UE may allocate the maximum available transmit power P_{CMAX} to the S-SSBs on the RB set #0, the RB set #1 and the RB set #2 determined in S111. For example, the power allocated to the S-SSB on RB set #0 is P′, the power allocated to the S-SSB on RB set #1 is P′1, and the power allocated to the S-SSB on RB set #2 is P′2. P′+P′1+P′2=P_{CMAX}.

At S113, the UE performs channel access/LBT.

In this operation, the UE may perform channel access/LBT on RB set #1, RB set #2 and RB set #3. In the example of FIG. 22, channel access of RB set #2 fails, and channel access of RB set #0 and RB set #1 succeeds.

At S114, the UE re-performs frequency domain power allocation/power control according to the channel access result.

In this operation, the UE may reallocate the maximum available transmit power P_{CMAX} to the RB set (that is, the RB set #0 and the RB set #1) for which channel access is successful in S113. For example, the power allocated to the S-SSB on the RB set #0 is P″, and the power allocated to the S-SSB on the RB set #1 is P′3. The power of the S-SSB on the anchor RB set (RB set #0) and the non-anchor RB set (RB set #1) are both reallocated, and P″+P′3=P_{CMAX}.

At S115, the UE transmits the S-SSB.

In this operation, the UE may transmit the S-SSB on the RB set #0 and the RB set #1 corresponding to the slot n according to the power allocated in S114.

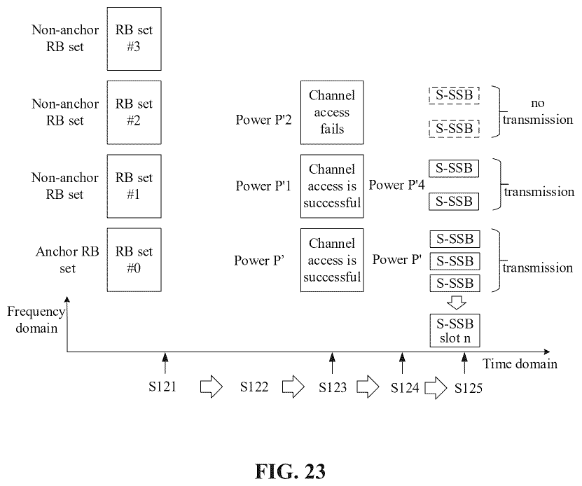

FIG. 23 illustrates an example of the second implementation in the first solution. The flow shown in FIG. 23 may include the following operations S121 to S125.

At S121, the UE determines that the frequency domain resource which is to transmit the S-SSB in slot n (S-SSB slot n) includes RB set #0, RB set #1 and RB set #2, and may determine the number of repetitive S-SSBs transmitted on each RB set, and an interval between adjacent S-SSBs in one RB set or the like. The RB set #0 is an anchor RB set, and the RB set #1 and the RB set #2 are non-anchor RB sets.

At S122, the UE performs frequency domain power allocation/power control.

In this operation, the UE may allocate the maximum available transmit power P_{CMAX} to the S-SSBs on the RB set #0, the RB set #1 and the RB set #2 determined in S121. For example, the power allocated to the S-SSB on RB set #1 is P′, the power allocated to the S-SSB on RB set #1 is P′1, and the power allocated to the S-SSB on RB set #2 is P′2. P′+P′1+P′2=P_{CMAX}.

At S123, the UE performs channel access/LBT.

In this operation, the UE may perform channel access/LBT on RB set #1, RB set #2 and RB set #3. In the example of FIG. 23, channel access of RB set #2 fails, and channel access of RB set #0 and RB set #1 succeeds.

At S124, the UE re-performs frequency domain power allocation/power control according to the channel access result.

In this operation, the UE may reallocate the maximum available transmit power P_{CMAX} to the RB set (that is, the RB set #0 and the RB set #1) for which the channel access is successful in S123, and the power allocated to the S-SSB on the anchor RB set (RB set #0) is the same as the power allocated to the S-SSB on the anchor RB set in S122, which is P′. The power allocated to the S-SSB on the RB set #1 is P′4, P′ 4 is the remaining power in the maximum available transmit power P_{CMAX}, that is, P′+P′4=P_{CMAX}.

At S125, the UE transmits the S-SSB.

In this operation, the UE may transmit the S-SSB on the RB set #0 and the RB set #1 corresponding to the slot n according to the power allocated in S124.

### Second Solution

In the second solution, the UE does not perform power allocation in advance, and may wait for the channel access result, and performs power control/power allocation according to the channel access result. The process of the second solution may include the following operations.

21) The UE decides to transmit the S-SSBs on the target RB sets k₀, k₁, . . . , kₙ corresponding to the time slot n.

22) The UE performs channel access/LBT on the target RB sets k₀, k₁, . . . , kₙ.

23) According to the channel access result, the UE allocates the maximum available transmit power P_{CMAX} to the S-SSB on the RB set for which channel access is successful, and transmits the S-SSB in the time slot n.

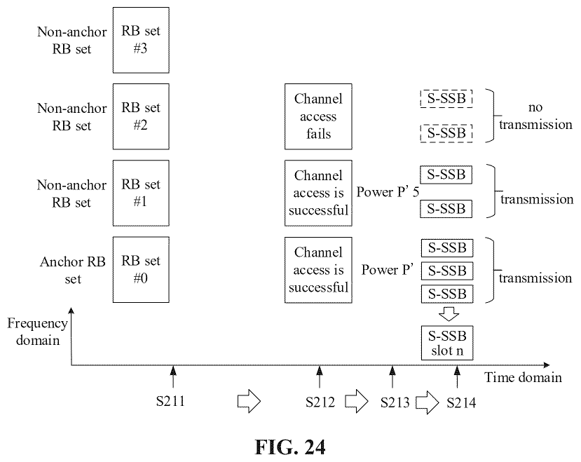

For ease of understanding, FIG. 24 shows an example of the second solution. The flow illustrated in FIG. 24 may include the following operations S211 to S214.

At S211, the UE determines that frequency domain resources which are to transmit the S-SSB in slot n (S-SSB slot n) include RB set #0, RB set #1 and RB set #2, and may determine the number of repetitive S-SSBs transmitted on each RB set, and an interval between adjacent S-SSBs in one RB set or the like. The RB set #0 is an anchor RB set, and the RB set #1 and the RB set #2 are non-anchor RB sets.

At S212, the UE performs channel access/LBT.

In this operation, the UE may perform channel access/LBT on RB set #0, RB set #1 and RB set #2. In the example of FIG. 24, channel access of RB set #2 fails, and channel access of RB set #0 and RB set #1 succeeds.

At S213, the UE performs frequency domain power allocation/power control according to the channel access result. P_{CMAX} to the RB set (that is, the RB set #0 and the RB set #1) for which channel access is successful in S212. For example, the power allocated to the S-SSB on the RB set #0 is P′, the power allocated to the S-SSB on the RB set #1 is P′5, and P′+P′5=P_{CMAX}.

At S214, the UE transmits the S-SSB.

In this operation, the UE may transmit the S-SSB on the RB set #0 and the RB set #1 corresponding to the slot n in accordance with the power allocated in S213.

According to the method of the embodiment of the present disclosure, the UE can readjust the power control/power allocation according to the channel access result, and the allocated power that cannot be used since the channel access fails can be reused for transmitting the S-SSB when the channel access is successful, so that the transmit power can be used to the maximum extent, and the transmission/detection effect of the synchronization signal can be ensured.

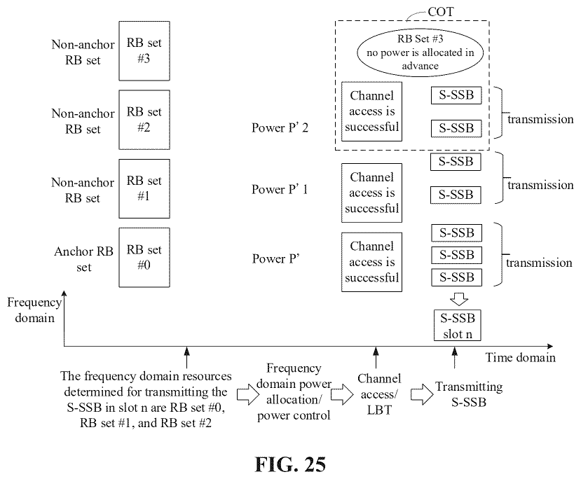

In some scenarios, when the UE determines the RB set which is to transmit the S-SSB, the UE cannot yet acquire whether there is a COT in a time slot in which the S-SSB is transmitted, and does not acquire which RB set is included in the COT. Therefore, there may be a situation in which the RB set which is determined in advance to transmit the S-SSB cannot completely overlap with the RB set included in the COT in the time slot in which the S-SSB is to be transmitted, that is, the RB set included in the COT includes a different RB set from the RB set which is determined in advance to transmit the S-SSB, and the different RB set is not considered in the power allocation performed in advance. For this case, there is no solution yet which discloses whether channel access is required for the RB set. Assuming that the channel access of the RB set is successful, and if the S-SSB is to be transmitted on the RB set, there is no power allocated in advance to the S-SSB on the RB set. For example, in FIG. 25, there is no COT when which RB sets are used to transmit the S-SSB is determined in the first operation, and there is no plan to transmit the S-SSB in RB set #3, and no power is allocated to RB set #3 at the time of frequency domain power control/power allocation, and the total transmit power (maximum available transmit power P_{CMAX}) is all allocated to RB set #0, RB set #1, and RB set #2. However, there is COT when the channel access is performed or before the time slot n where the S-SSB is transmitted. If occupancy is continuous and maintained in the COT, the S-SSB needs to be transmitted on the RB set #3 in the time slot n to ensure that the resources in the COT can continue to be occupied and maintained. However, since power is not allocated to the RB set #3 in advance, the S-SSB cannot be transmitted on the RB set #3 in the time slot n.

In view of this, the embodiment of the present disclosure proposes the third solution and the fourth solution. The COT is considered when performing channel access in the third solution and the fourth solution, and channel access and power control/power allocation for transmitting S-SSB is performed on this basis. In this way, the resources in the COT can be kept occupied, thereby avoiding preempting the resources in the COT by the user of other system.

### Third Solution

In the third solution, the UE may consider COT information (corresponding to configuration information of the COT in the foregoing embodiment) when performing channel access, and readjust power control/power allocation according to the channel access result. The process of the third solution may include the following operations.

31) The UE decides to transmit the S-SSB on the target RB sets k₀, k₁, . . . , kₙ in the time slot n, and performs power control/power allocation on the S-SSB on the RB sets k₀, k₁, . . . , kₙ in the frequency domain.

32) At time (n-t₁) before time slot n, the UE acquires COT information (COT may be initiated by the UE, or may be shared to the UE by other UEs), and the COT includes RB sets kₘ, . . . , k_{d}.

In a possible case (denoted as case #1), the RB sets kₘ, . . . , k_{d} contained in the COT are a subset of the target RB sets k₀, k₁, . . . , kₙ. In this case, it can be implemented according to the first solution. That is, channel access/LBT is performed on the target RB sets k₀, k₁, . . . , kₙ, and power control/power allocation is re-performed on the S-SSBs on the target RB sets k₀, k₁, . . . , kₙ according to the channel access result.

In another possible case (denoted as case #2), the RB sets kₘ, . . . , k_{d} included in the COT are not a subset of the target RB sets k₀, k₁, . . . , kₙ. That is, the RB sets kₘ, . . . , k_{d} partially overlap or do not completely overlap with the target RB sets k₀, k₁, . . . , kₙ. In this case, the UE may reset the target RB set to be a union of the RB sets kₘ, . . . , k_{d} and the original target RB sets k₀, k₁, . . . , kₙ. Accordingly, the UE may re-perform power control/power allocation on the S-SSB on the new target RB set (i.e., the union of the RB set kₘ, . . . , k_{d} and the original target RB set k₀, k₁, . . . , kₙ) at time (n-t₂). t₂≤t₁.

For the above case #2, that is, in a case where the RB sets kₘ, . . . , k_{d} included in the COT are not a subset of the target RB sets k₀, k₁, . . . , kₙ, the channel access includes two scenarios as follows.

In the first scenario, if the channel access of the new target RB set has not been completed when the power control/power allocation of the S-SSB is re-performed at time (n-t₂), the power control/power allocation is performed on the S-SSB on the new target RB set. After the channel access of the new target RB set is completed, power control/power adjustment may be performed on the S-SSB on the RB set for which channel access is successful according to the channel access result.

In the second scenario, if the channel access of the new target RB set has been completed when the power control/power allocation of the S-SSB is re-performed at time (n-t₂), power control/power adjustment may be performed on the S-SSB on the RB set for which channel access is successful according to the channel access result on the new target RB set.

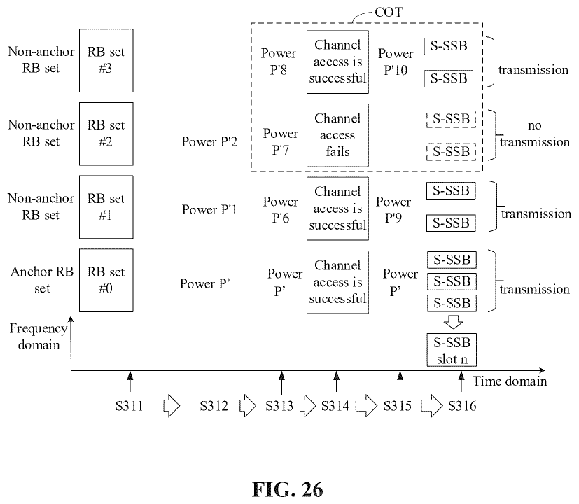

For ease of understanding, FIG. 26 shows an example of third solution. The flow illustrated in FIG. 26 may include the following operations S311 to S316.

At S311, the UE determines that frequency domain resources which are to transmit the S-SSB in slot n (S-SSB slot n) include RB set #0, RB set #1 and RB set #2, and may determine the number of repetitive S-SSBs transmitted on each RB set, and an interval between adjacent S-SSBs in one RB set or the like. The RB set #0 is an anchor RB set, and the RB set #1 and the RB set #2 are non-anchor RB sets.

At S312, the UE performs frequency domain power allocation/power control.

In this operation, the UE may allocate the maximum available transmit power P_{CMAX} to the S-SSBs on the RB set #0, the RB set #1 and the RB set #2 determined in S311. For example, the power allocated to the S-SSB on RB set #0 is P′, the power allocated to the S-SSB on RB set #1 is P′1, and the power allocated to the S-SSB on RB set #2 is P′2. P′+P′1+P′2=P_{CMAX}.

At S313, frequency domain power allocation/power control is re-performed according to COT information.

If the UE acquires the COT information after completing power control/power allocation for the RB set #0, the RB set #1 and the RB set #2, the UE may set a union of the RB set included in the COT and the RB set #0, the RB set #1, and the RB set #2 as the target RB set. For example, in FIG. 26, since the COT includes RB set #2 and RB set #3, the target RB set includes RB set #0, RB set #1, RB set #2 and RB set #3. The UE may re-perform power control/power allocation on the target RB set. For example, the power allocated to the S-SSB on RB set #0 is P′, the power allocated to the S-SSB on RB set #1 is P′6, the power allocated to the S-SSB on RB set #2 is P′7, and the power allocated to the S-SSB on RB set #3 is P′8. Where P′+P′6+P′7+P′8=P_{CMAX}.

At S314, the UE performs channel access/LBT.

In this operation, the UE may perform channel access/LBT on the target RB set (RB set #0, RB set #1, RB set #2 and RB set #3). In the example of FIG. 26, channel access of RB set #2 fails, and channel access of RB set #0, RB set #1 and RB set #3 succeeds.

At S315, the UE re-performs frequency domain power allocation/power control according to the channel access result.

In this operation, the UE may allocate the maximum available transmit power P_{CMAX} to RB sets (that is, RB set #0, RB set #1 and RB set #3) for which channel access is successful in S314. For example, the power allocated to the S-SSB on the RB set #0 is P′, the power allocated to the S-SSB on the RB set #1 is P′9, the power allocated to the S-SSB on the RB set #3 is P′10, and P′+P′9+P′10=P_{CMAX}.

At S316, the UE transmits the S-SSB.

In this operation, the UE may transmit the S-SSBs on the RB set #0, RB set #1 and RB set #3 corresponding to the slot n according to the power allocated in S315.

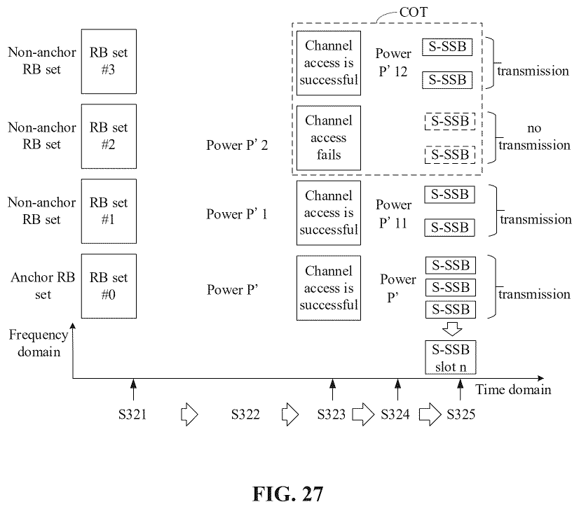

FIG. 27 shows another example of the third solution. The flow illustrated in FIG. 27 may include the following operations S321 to S325.

At S321, the UE determines that frequency domain resources which are to transmit the S-SSB in slot n (S-SSB slot n) include RB set #0, RB set #1 and RB set #2, and may determine the number of repetitive S-SSBs transmitted on each RB set, and an interval between adjacent S-SSBs in one RB set or the like. The RB set #0 is an anchor RB set, and the RB set #1 and the RB set #2 are non-anchor RB sets.

At S322, the UE performs frequency domain power allocation/power control. P_{CMAX} to the S-SSBs on the RB set #0, the RB set #1 and the RB set #2 determined in S321. For example, the power allocated to the S-SSB on RB set #0 is P′, the power allocated to the S-SSB on RB set #1 is P′1, and the power allocated to the S-SSB on RB set #2 is P′2. P′+P′1+P′2=P_{CMAX}.

At S323, the UE performs channel access/LBT.

When the UE acquires the COT information after completing power control/power allocation for the RB set #0, the RB set #1 and the RB set #2, the UE may set a union of the RB set included in the COT and the RB set #0, the RB set #1 and the RB set #2 as the target RB set. For example, in FIG. 27, since the COT includes RB set #2 and RB set #3, the target RB set includes RB set #0, RB set #1, RB set #2 and RB set #3. The UE may perform channel access/LBT on the target RB set. In the example of FIG. 27, channel access of RB set #2 fails, and channel access of RB set #0, RB set #1, and RB set #3 succeeds.

At S324, the UE re-performs frequency domain power allocation/power control according to the channel access result.

In this operation, the UE may allocate the maximum available transmit power P_{CMAX} to the RB sets (that is, RB set #0, RB set #1 and RB set #3) for which channel access is successful in S323. For example, the power allocated to the S-SSB on the RB set #0 is P′, the power allocated to the S-SSB on the RB set #1 is P′11, the power allocated to the S-SSB on the RB set #3 is P′12, and P′+P′11+P′12=P_{CMAX}.

At S325, the UE transmits the S-SSB.

In this operation, the UE may transmit the S-SSBs on RB set #0, RB set #1 and RB set #3 corresponding to slot n in accordance with the power allocated in S324.

### Fourth Solution

In the fourth solution, the UE may consider COT information when performing channel access, and the UE may not need to perform power allocation in advance, and may wait for a channel access result, and perform power control/power allocation according to the channel access result. The process of the fourth solution may include the following operations.

41) The UE decides to transmit the S-SSB on the target RB sets k₀, k₁, . . . , kₙ corresponding to the time slot n.

42) The UE acquires COT information before the time slot n (the COT may be initiated by the UE, or may be may be shared to the UE by other UEs), and the COT includes RB sets kₘ, . . . , k_{d}.

In a possible case, the RB sets kₘ, . . . , k_{d} included in the COT are a subset of the target RB sets k₀, k₁, . . . , kₙ. In this case, the original target RB sets k₀, k₁, . . . , kₙ remain unchanged, and the channel access is performed on the target RB sets k₀, k₁, . . . , kₙ. In another possible case, the RB sets kₘ, . . . , k_{d} included in the COT is not a subset of the target RB sets k₀, k₁, . . . , kₙ. That is, the RB sets kₘ, . . . , k_{d} partially overlap or do completely not overlap with the target RB sets k₀, k₁, . . . , kₙ. In this case, the UE may reset the target RB set to be a union of the RB sets kₘ, . . . , k_{d} and the original target RB sets k₀, k₁, . . . , kₙ. Thus, the UE may perform channel access on the reset target RB set.

43) According to the channel access result, the UE allocates the maximum available transmit power P_{CMAX} to the S-SSB on the RB set for which channel access is successful, and transmits the S-SSB in the time slot n.

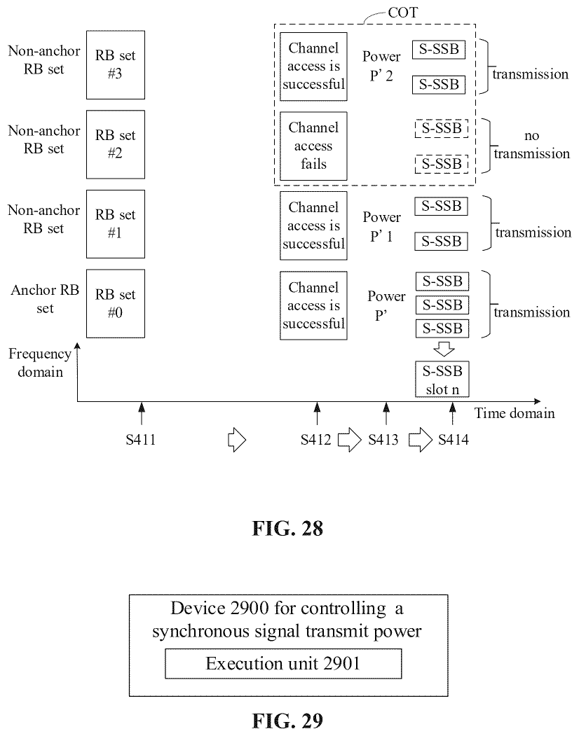

For ease of understanding, FIG. 28 shows an example of the fourth solution. The flow illustrated in FIG. 28 may include the following operations S411 to S414.

At S411, the UE determines that frequency domain resources which are to transmit the S-SSB in slot n (S-SSB slot n) include RB set #0, RB set #1 and RB set #2, and may determine the number of repetitive S-SSBs transmitted on each RB set, and an interval between adjacent S-SSBs in one RB set or the like. The RB set #0 is an anchor RB set, and the RB set #1 and the RB set #2 are non-anchor RB sets

At S412, the UE performs channel access/LBT.

When the UR acquires the COT information in advance, the UR may set the union of the RB set included in the COT and the RB set #0, the RB set #1 and the RB set #2 as the target RB set. For example, in FIG. 28, since the COT includes RB set #2 and RB set #3, the target RB set includes RB set #0, RB set #1, RB set #2 and RB set #3. The UE may perform channel access/LBT on the target RB set. In the example of FIG. 28, channel access of RB set #2 fails, and channel access of RB set #0, RB set #1 and RB set #3 succeeds.

At S413, the UE performs frequency domain power allocation/power control according to the channel access result. P_{CMAX} to the RB set (that is, RB set #0, RB set #1 and RB set #3) for which the channel access is successful in S412. For example, the power allocated to the S-SSB on the RB set #0 is P′, the power allocated to the S-SSB on the RB set #1 is P′1, the power allocated to the S-SSB on the RB set #3 is P′2, and P′+P′1+P′2=P_{CMAX}.

At S414, The UE transmits the S-SSB.

In this operation, the UE may transmit the S-SSB on the RB set #0, RB set #1 and RB set #3 corresponding to the slot n according to the power allocated in S413.

According to the method of the embodiment of the present disclosure, the UE can re-perform power control/power allocation according to the channel access result, and the allocated power that cannot be used since the channel access fails can be re-used for transmitting the S-SSB when the channel access is successful, so that the transmit power can be used to the maximum extent, and the transmission/detection effect of the synchronization signal can be ensured. In addition, the COT is considered when performing channel access, and channel access and power control/power allocation for transmitting S-SSB is performed on this basis. In this way, the resources in the COT can be kept occupied, thereby avoiding preempting the resources in the COT by the user of other system.

The preferred embodiments of the present disclosure have been described in detail above with reference to the accompanying drawings, but the present disclosure is not limited to the specific details in the above-described embodiments. Within the scope of the technical concept of the present disclosure, various simple modifications can be made to the technical solutions of the present disclosure, and these simple modifications all fall within the scope of protection of the present disclosure. For example, various specific technical features described in the above-described detailed description can be combined in any suitable manner without contradiction, and various possible combinations will not be described separately in present disclosure in order to avoid unnecessary repetition. For example, various embodiments of the present disclosure may be combined arbitrarily, and as long as they do not violate the idea of the present disclosure, they should also be regarded as the disclosure of the present disclosure. For another example, on the premise that there is no conflict, all embodiments described in the present disclosure and/or the technical features in the embodiments can be arbitrarily combined with the prior art, and the technical solution obtained after the combination should also fall within the scope of protection of the present disclosure.

It should also be understood that in various method embodiments of the present disclosure, the size of the sequence number of the above-described processes does not mean the sequence of execution, and the sequence of execution of each process should be determined by its function and internal logic, and should not constitute any limitation on the implementation of the embodiments of the present disclosure. In addition, in the embodiment of the present disclosure, the terms “downlink”, “uplink”, and “sidelink” are used to indicate the transmission direction of a signal or data, where “downlink” indicates that the transmission direction of a signal or data is a first direction transmitted from the station to the user equipment of the cell, “uplink” indicates that the transmission direction of a signal or data is a second direction transmitted from the user equipment of the cell to the station, and “sidelink” indicates that the transmission direction of a signal or data is a third direction transmitted from the user equipment 1 to the user equipment 2. For example, “downlink signal” indicates that the transmission direction of the signal is the first direction. In addition, in the embodiment of the present disclosure, the term “and/or” is only one kind of association relationship describing an association object, and indicates that there may be three kinds of relationships. Specifically, A and/or B may represent three cases of A alone, A and B simultaneously, and B alone. In addition, the character “/” herein generally indicates that the related objects before and after are in an “or” relationship.

Based on the foregoing embodiments, the embodiments of the present disclosure provide a device for controlling a synchronization signal transmit power.

FIG. 29 is a schematic structural diagram of a composition of a device for controlling a synchronization signal transmit power provided by the embodiment of the present disclosure, and the device is applied to a terminal. As shown in FIG. 29, the device 2900 (simply referred to as the device 2900 hereinafter) for controlling a synchronization signal transmit power includes an execution unit 2901.

The execution unit 2901 is configured to execute channel access on at least one first resource block RB set, and determine a first sidelink synchronization signal block S-SSB transmit power on the at least one first RB set based on the channel access result of the at least one first RB set.

In some embodiments, the sum of the first S-SSB transmit powers on the first RB set for which channel access result is successful in the at least one first RB set is the maximum available transmit power.

In some embodiments, the at least one first RB set includes an anchor RB set. The first RB set for which the channel access result indicates success includes an anchor RB set, or the first RB set for which the channel access result indicates success does not include the anchor RB set.

In some embodiments, the at least one first RB set includes the anchor RB set. When the channel access result of the anchor RB set indicates failure, the first S-SSB transmit power on the at least one first RB set is 0.

In some embodiments, the device 2900 further includes a first determining unit configured to determine a second S-SSB transmit power on the at least one first RB set before performing channel access on the at least one first RB set. The sum of the second S-SSB transmit powers on the at least one first RB set is the maximum available transmit power.

In some embodiments, when the channel access result of all the at least one first RB set indicates success, the first S-SSB transmit power on each first RB set is the same as the second S-SSB transmit power on the respective first RB set.

In some embodiments, the at least one first RB set includes an anchor RB set. When the channel access result of the anchor RB set indicates success, the first S-SSB transmit power on the anchor RB set is the same as or different from the second S-SSB transmit power on the anchor RB set.

In some embodiments, the at least one first RB set is a frequency domain resource for transmitting the S-SSB determined before performing channel access.

In some embodiments, the device 2900 further includes an acquisition unit configured to acquire configuration information of channel occupancy time COT, and the configuration information of the COT is used to configure at least one second RB set included in the COT. The at least one first RB set includes at least one third RB set and at least one second RB set. The third RB set is a frequency domain resource for transmitting the S-SSB determined before performing channel access.

In some embodiments, the configuration information of the COT is determined by the device 2900. Alternatively, the configuration information of the COT comes from another terminal.

In some embodiments, the at least one third RB set includes at least one second RB set. Alternatively, at least one third RB set does not include at least one second RB set. Alternatively, the at least one third RB set and the at least one second RB set have partially identical RB set.

In some embodiments, the device 2900 further includes a second determining unit configured to determine a third S-SSB transmit power on the at least one first RB set in case where the channel access is not completed. The sum of the third S-SSB transmit powers on the at least one first RB set is the maximum available transmit power.

In some embodiments, the at least one first RB set includes an anchor RB set. When the channel access result of the anchor RB set indicates success, the first S-SSB transmit power on the anchor RB set is the same or different from the third S-SSB transmit power on the anchor RB set.

In some embodiments, the device 2900 further includes: a third determining unit configured to determine a fourth S-SSB transmit power on at least one third RB set before acquiring configuration information of the COT. The sum of the fourth S-SSB transmit powers on the at least one third RB set is the maximum available transmit power.

In some embodiments, the at least one third RB set includes an anchor RB set. When the channel access result of the anchor RB set indicates success, the first S-SSB transmit power on the anchor RB set is the same as or different from the fourth S-SSB transmit power on the anchor RB set.

In some embodiments, the device 2900 further includes: a fourth determining unit configured to determine a third S-SSB transmit power on the at least one first RB set in a case where the channel access is not completed. The sum of the third S-SSB transmit powers on the at least one first RB set is the maximum available transmit power.

In some embodiments, the at least one third RB set includes an anchor RB set. The third S-SSB transmit power on the anchor RB set is the same as or different from the fourth S-SSB transmit power on the anchor RB set. When the channel access result of the anchor RB set indicates success, the first S-SSB transmit power on the anchor RB set is the same or different from the third S-SSB transmit power on the anchor RB set.

In some embodiments, the device 2900 further includes a transmitting unit configured to, for each of the at least one first RB set, transmit an S-SSB on the first RB set based on the first S-SSB transmit power on the first RB set when the first S-SSB transmit power on the first RB set is not 0.

Those skilled in the art should understand that the related description of the above-described device for controlling a synchronization signal transmit power according to the embodiment of the present disclosure can be understood with reference to the related description of the method for controlling a synchronization signal transmit power according to the embodiment of the present disclosure.

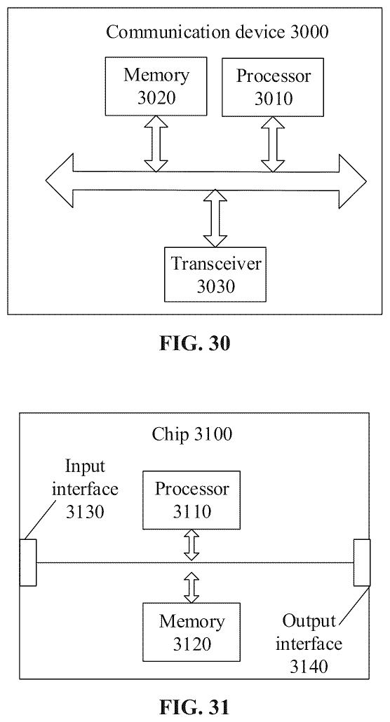

FIG. 30 is a schematic structural diagram of a communication device 3000 according to an embodiment of the present disclosure. The communication device 3000 shown in FIG. 30 includes a processor 3010, and the processor 3010 can call and run a computer program from a memory to implement the method in the embodiment of the present disclosure.

Optionally, as shown in FIG. 30, the communication device 3000 may further include a memory 3020. The processor 3010 may call and run a computer program from the memory 3020 to implement the method in the embodiment of the present disclosure.

The memory 3020 may be a separate device independent of the processor 3010 or may be integrated into the processor 3010.

Alternatively, as shown in FIG. 30, the communication device 3000 may further include a transceiver 3030, and the processor 3010 may control the transceiver 3030 to communicate with other devices. Specifically, the processor 3010 may control the transceiver 3030 to transmit information or data to other devices, or may receive information or data transmitted by other devices.

Here, the transceiver 3030 may include a transmitter and a receiver. The transceiver 3030 may further include one or more antennas.

Specifically, the communication device 3000 may be a terminal according to the embodiment of the present disclosure, and the communication device 3000 may implement corresponding flows implemented by the terminal in each method according to the embodiment of the present disclosure, and will not be described herein for the sake of conciseness.

FIG. 31 is a schematic structural diagram of a chip according to an embodiment of the present disclosure. The chip 3100 shown in FIG. 31 includes a processor 3110, and the processor 3110 can call and run a computer program from a memory to implement the method in the embodiment of the present disclosure.

Optionally, as shown in FIG. 31, the chip 3100 may further include a memory 3120. The processor 3110 may call and run a computer program from the memory 3120 to implement the method in the embodiment of the present disclosure.

The memory 3120 may be a separate device independent of the processor 3110 or may be integrated into the processor 3110.

Optionally, the chip 3100 may further include an input interface 3130. The processor 3110 may control the input interface 3130 to communicate with other devices or chips. Specifically, the processor 3110 may control the input interface 3130 to acquire information or data transmitted by other devices or chips.

Optionally, the chip 3100 may further include an output interface 3140. The processor 3110 may control the output interface 3140 to communicate with other devices or chips. Specifically, the processor 3110 may control the output interface 3140 to output information or data to other devices or chips.

The chip may be applied to the terminal in the embodiment of the present disclosure, and the chip can implement the corresponding flows implemented by the terminal in each method according to the embodiment of the present disclosure, and will not be repeatedly described here for the sake of simplicity.

It should be understood that the chip mentioned in the embodiments of the present disclosure may also be referred to as a system level chip, a system chip, a system-on-chip or a system-on-chip chip.

It should be understood that the processor of the embodiment of the present disclosure may be an integrated circuit chip having signal processing capabilities. In the implementation process, the steps of the above-described method embodiments may be completed by integrated logic circuits of hardware in the processor or instructions in the form of software. The processor described above may be a general-purpose processor, a Digital Signal Processor (DSP), an Application Specific Integrated Circuit (ASIC), a Field Programmable Gate Array (FPGA) or other programmable logic device, a discrete gate or transistor logic device or a discrete hardware component. The methods, steps, and logical block diagrams disclosed in the embodiments of the present disclosure may be implemented or executed. The general-purpose processor may be a microprocessor or the processor may be any conventional processor or the like. The steps of the method disclosed in connection with the embodiments of the present disclosure may be directly embodied to be executed by the hardware decoding processor, or executed by combining hardware and software modules in the decoding processor. The software module may be located in a storage medium mature in the art, such as a random access memory, a flash memory, a read-only memory, a programmable read-only memory, or an electrically erasable programmable memory, registers, etc. The storage medium is located in the memory, and the processor reads the information in the memory, and complete the steps of the above method in conjunction with hardware thereof.

It is understood that the memory in the embodiments of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of illustration, but not by way of limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memory of the systems and methods described herein is intended to include, but is not limited to, these and any other suitable type of memory.

It should be understood that the above memory is illustrative but not restrictive, for example, the memory in the embodiments of the present disclosure may also be a static random access memory (SRAM), a dynamic random access memory (DRAM), a synchronous dynamic random access memory (SDRAM), a double data rate synchronous dynamic random access memory (DDR SDRAM), an enhanced SDRAM (ESDRAM), a synch link dynamic random access memory (SLDRAM), a Direct Rambus RAM (DR RAM), and the like. That is, the memory in the embodiments of the present disclosure is intended to include, but is not limited to, these and any other suitable type of memory.

The embodiments of the present disclosure further provide a computer-readable storage medium for storing a computer program. The computer-readable storage medium can be applied to the terminal in the embodiment of the present disclosure, and the computer program causes the computer to execute corresponding flows implemented by the terminal in each method of the embodiment of the present disclosure, and will not be described herein for the sake of brevity.

The embodiments of the present disclosure further provide a computer program product including computer program instructions. The computer program product can be applied to the terminal in the embodiment of the present disclosure, and the computer program instruction causes the computer to execute the corresponding flows implemented by the terminal in each method of the embodiment of the present disclosure, and will not be described herein for the sake of brevity.

The embodiments of the present disclosure further provide a computer program. The computer program can be applied to the terminal in the embodiment of the present disclosure, and when the computer program is run on the computer, the computer executes the corresponding flows implemented by the terminal in each method of the embodiment of the present disclosure, and the description thereof is not repeated here for the sake of simplicity.

Those of ordinary skill in the art will appreciate that the elements and algorithmic steps of the various examples described in connection with the embodiments disclosed herein can be implemented in electronic hardware, or a combination of computer software and electronic hardware. Whether these functions are performed in hardware or software depends on the specific application and design constraints of the technical solution. Those skilled in the art may use different methods for implementing the described functions for each particular application, but such implementations should not be considered beyond the scope of the present disclosure.

Those skilled in the art can clearly understand that, for convenience and conciseness of the description, the specific operation processes of the systems, devices, and units described above are not repeatedly described by referring to the corresponding processes in the above-described method embodiments.

In the embodiments provided herein, it should be understood that the disclosed systems, apparatuses and methods may be implemented in other ways. For example, the device embodiments described above are merely schematic, for example, the division of units is only one logical function division, and there may be other division methods in actual implementation. For example, multiple units or components may be combined or integrated into another system, or some features may be ignored or not implemented. In addition, the coupling or direct coupling or communication connection shown or discussed may be an indirect coupling or communication connection through some interface, device or unit, which may be electrical, mechanical or otherwise.

The units described as separate components may be or may not be physically separate, and the components displayed as units may or may not be physical units, that is, they may be located in one place or may be distributed over a plurality of network units. Some or all of the units may be selected according to actual needs to achieve the purpose of the solution of the present embodiment.

In addition, all the functional units in each embodiment of the present disclosure may be integrated in one processing unit, or may be physically present alone, or two or more units may be integrated in one unit.

The functions may be stored in a computer-readable storage medium if the functions are implemented in the form of software functional units and sold or used as independent products. Based on this understanding, an essential part or a part contributing to the prior art of the technical solution of the present disclosure or a part of the technical solution may be embodied in the form of a software product. The computer software product is stored in a storage medium and includes several instructions for causing a computer device (which may be a personal computer, a server, or a network device, etc.) to perform all or part of the steps of the method described in various embodiments of the present disclosure. The storage medium includes a USB disk, a removable hard disk, a Read-Only Memory (ROM), a Random Access Memory (RAM), a magnetic disk or an optical disk, or a medium that can store program codes.

The foregoing is merely a specific embodiment of the present disclosure, but the scope of protection of the present disclosure is not limited thereto, and changes or substitutions which can be easily conceived by any person skilled in the art within the technical scope disclosed in the present disclosure, should fall within the scope of protection of the present disclosure. Therefore, the scope of protection of the present disclosure should conform to the scope of protection of the claims.

1. A method for controlling a synchronization signal transmit power applied to a terminal, the method comprising:
performing channel access on at least one first resource block (RB) set; and
determining a first sidelink synchronization signal block (S-SSB) transmit power on the at least one first RB set based on a channel access result of the at least one first RB set.

2. The method of claim 1, wherein,
a sum of the first S-SSB transmit power on the first RB set for which the channel access result indicates success among the at least one first RB set is a maximum available transmit power.

3. The method of claim 2, wherein the at least one first RB set comprises an anchor RB set,
the first RB set for which the channel access result indicates success comprises the anchor RB set; or,
the first RB set for which the channel access result indicates success does not comprise the anchor RB set.

4. The method of claim 1, wherein the at least one first RB set comprises an anchor RB set,
in response to the channel access result of the anchor RB set indicating failure, the first S-SSB transmit power on the at least one first RB set is 0.

5. The method of claim 1, further comprising: before the performing channel access on the at least one first RB set,
determining a second S-SSB transmit power on the at least one first RB set, wherein a sum of the second S-SSB transmit power on the at least one first RB set is a maximum available transmit power.

6. The method of claim 5, wherein,
in response to the channel access result of all the at least one first RB set indicating success, the first S-SSB transmit power on each of the at least one first RB set is the same as the second S-SSB transmit power on the respective first RB set.

7. The method of claim 5, wherein the at least one first RB set comprises an anchor RB set,
in response to the channel access result of the anchor RB set indicating success, the first S-SSB transmit power on the anchor RB set is the same as or different from the second S-SSB transmit power on the anchor RB set.

8. The method of claim 1, wherein,
the at least one first RB set is a frequency domain resource for transmitting an S-SSB determined before the performing the channel access.

9. The method of claim 1, further comprising:
acquiring configuration information of a channel occupancy time (COT), wherein the configuration information of the COT is used to configure at least one second RB set contained in the COT,
wherein the at least one first RB set comprises at least one third RB set and the at least one second RB set, and the third RB set is a frequency domain resource for transmitting an S-SSB determined before the performing the channel access.

10. The method of claim 9, wherein
the configuration information of the COT is determined by the terminal; or,
the configuration information of the COT is from another terminal.

11. The method of claim 9, wherein,
the at least one third RB set comprises the at least one second RB set; or,
the at least one third RB set does not comprise the at least one second RB set; or,
a part of RB set in the at least one third RB set is identical to a part of RB set in the at least one second RB set.

12. The method of claim 1, further comprising:
determining a third S-SSB transmit power on the at least one first RB set when the channel access is not completed, wherein a sum of the third S-SSB transmit power on the at least one first RB set is a maximum available transmit power.

13. The method of claim 12, wherein the at least one first RB set comprises an anchor RB set,
in response to the channel access result of the anchor RB set indicating success, the first S-SSB transmit power on the anchor RB set is the same as or different from the third S-SSB transmit power on the anchor RB set.

14. The method of claim 9, further comprising: before the acquiring configuration information of the COT,
determining a fourth S-SSB transmit power on the at least one third RB set, wherein a sum of the fourth S-SSB transmit power on the at least one third RB set is a maximum available transmit power.

15. The method of claim 14, wherein the at least one third RB set comprises an anchor RB set,
in response to the channel access result of the anchor RB set indicating success, the first S-SSB transmit power on the anchor RB set is the same as or different from the fourth S-SSB transmit power on the anchor RB set.

16. The method of claim 14, further comprising:
determining a third S-SSB transmit power on the at least one first RB set when the channel access is not completed, wherein a sum of the third S-SSB transmit power on the at least one first RB set is a maximum available transmit power.

17. The method of claim 16, wherein the at least one third RB set comprises an anchor RB set,
the third S-SSB transmit power on the anchor RB set is the same as or different from the fourth S-SSB transmit power on the anchor RB set; and
in response to the channel access result of the anchor RB set indicating success, the first S-SSB transmit power on the anchor RB set is the same as or different from the third S-SSB transmit power on the anchor RB set.

18. The method of claim 1, further comprising:
for each of the at least one first RB set, if the first S-SSB transmit power on the first RB set is not 0, transmitting an S-SSB on the first RB set based on the first S-SSB transmit power on the first RB set.

19. A terminal comprising: a processor and a memory, wherein the memory is configured for storing a computer program, and the processor is configured for invoking and executing the computer program stored in the memory to implement:
performing channel access on at least one first resource block (RB) set; and
determining a first sidelink synchronization signal block (S-SSB) transmit power on the at least one first RB set based on a channel access result of the at least one first RB set.

20. A non-transitory computer readable storage medium for storing a computer program that causes a computer to implement:
performing channel access on at least one first resource block (RB) set; and
determining a first sidelink synchronization signal block (S-SSB) transmit power on the at least one first RB set based on a channel access result of the at least one first RB set.
